(19) United States
(12) Patent Application Publication
(10) Pub. No.: US 2008/0267465 A1
(43) Pub. Date: Oct. 30, 2008

(54) Operating Input Device and Operating Input Program

(75) Inventors: Masaaki Matsuo, Nagoya-shi (JP); Masahiro Hoguro, Kasugai-shi (JP); Tatsuki Yoshimine, Nagoya-shi (JP)

Correspondence Address: OLIFF & BERRIDGE, PLC, P.O. BOX 320850, ALEXANDRIA, VA, 22320-4850, US

(73) Assignee: KABUSHIKI KAISHA DDS, NAGOYA-SHI (JP)

(21) Appl. No.: 11/547,285

(22) PCT Filed: Apr. 30, 2004
(86) PCT No.: PCT/JP04/05845

§ 371 Date: Nov. 16, 2006

(51) Int. Cl. G06K 9/78

(52) U.S. Cl. 382/126

(57) ABSTRACT

A finger placement detection unit 51 detects whether or not a finger is placed on a fingerprint sensor. A finger area detection unit 52 computes area of a finger placed on the fingerprint sensor based on the finger placement detection result for small divided regions of the fingerprint sensor. A finger position detection unit 53 computes a position of the finger on the fingerprint sensor based on the detection result in the finger placement detection unit for the small divided regions of the fingerprint sensor. A finger release detection unit 54 detects whether or not the finger placed on the fingerprint sensor is released and outputs the respective results to a control information generation unit 50. Based on the output results, the control information generation unit 50 generates control information such as accelerator control information, handle control information, brake control information, etc. and outputs it to a game program.

### FIELD OF THE INVENTION

The present invention relates to an operating input device and an operating input program for operating an apparatus by entering a fingerprint image.

### BACKGROUND ART

Recently, with rapid progress of digitization or networking of information, interests in security techniques for controlling access to information have been growing. As one of such security techniques, a variety of products for authenticating identities by entering and checking fingerprints have become commercially available. Downsizing of such fingerprint input devices has been demanded, and they have become incorporated into portable telephones or handheld terminals.

If a fingerprint input device is incorporated into an apparatus, the fingerprint input device is usually used only for checking fingerprints, and thus a separate operating input means is provided for achieving intended purposes of the apparatus. For instance, if a portable phone has a fingerprint input device, the fingerprint input device may be used to limit access to an address book of the portable phone through checking of fingerprints. However, this fingerprint input device cannot be used for operating input into the address book, and generally, separately provided various keys on the portable phone are used for the purpose.

In such configuration, an attempt to incorporate fingerprint authentication function into a conventional apparatus would simply add a fingerprint input device to the conventional configuration, causing such problems as jumboizing of an apparatus, increased cost, and complicated operation.

In view of such problems, some proposals for using a fingerprint input device as a pointing device such as a mouse have been made (refer to Patent Document 1 to Patent Document 3, for instance). In addition, Patent Document 4 discloses a method for implementing operating input wherein a means for sensing how a finger is placed is provided on a fingerprint input device and senses how a finger is pressed, etc.

Patent Document 1: Japanese Patent Application Laid Open (Kokai) No. H11-161610

Patent Document 2: Japanese Patent Application Laid Open (Kokai) No. 2003-288160

Patent Document 3: Japanese Patent Application Laid Open (Kokai) No. 2002-62984

Patent Document 4: Japanese Patent Application Laid Open (Kokai) No. 2001-143051

### Problems to be Solved by the Invention

However, in the above-mentioned conventional method, it was necessary to use fingerprint input only as a pointing device or provide a special means for sensing pressing force, etc. Thus, time has not yet come to acquire various states of a finger when a fingerprint is entered and use it as operating information of an apparatus, and a fingerprint input device was inadequate to be used as an operating input device.

The present invention was made to solve the above problem and its object is to provide an operating input device and an operating input program for controlling operation of an apparatus by utilizing fingerprint images.

### Means for Solving the Problems

To achieve the above object, an operating input device of the present invention comprises an input means for inputting a fingerprint image, a state detection means for detecting a state of a finger placed on the input means, and a control information generation means for generating control information for a device based on detection result of the state detecting means, and is characterized in that the state detection means includes at least one of: a finger placement detection means for detecting that a finger is placed on the input means when either a density value of a fingerprint image input from the input means or a difference in density values of plural fingerprint images input from the input means exceeds a predetermined threshold; a finger release detection means for detecting that a finger has left the input means when either density values of plural fingerprint images input from the input means or a difference in the density values of plural fingerprint images input from the input means falls below a predetermined threshold; a finger movement detection means for detecting a travel distance or moving direction of a finger on the input means based on density values or area of plural fingerprint images continuously input from the regions of the input means that have been divided in advance; a finger position detection means for detecting a position of a finger on the input means based on density values or fingerprint area of plural fingerprint images continuously input from the regions of the input means that have been divided in advance; a finger contact area detection means for detecting contact area of a finger on the input means by calculating a difference between a density value of when no finger is placed on the input means and a density value of when a finger is placed on the input means; or a finger rhythm detection means for detecting rhythm of finger movement on the input means by either calculating variation in a fingerprint images input at predetermined time intervals or measuring time from finger placement to finger release on the input means.

In such a configuration, a fingerprint image is input from the input means, state of a finger on entry is detected by the state detection means, and control information of an apparatus is generated based on the detection result. Thus, operation of an apparatus can be carried out even without providing an input device dedicated for operation of an apparatus in addition to a fingerprint authentication device. In addition, the state detection means is configured to include at least one of: whether or not a finger was placed (the finger placement detection means), whether or not the placed finger left (the finger release detection means), detection of displacement or moving direction of a finger (the finger movement detection means), detection of a position where a finger is placed (the finger position detection means), detection of finger contact area (finger contact area detection means), or detection of whether movement of a finger is in accordance with a certain rhythm (the finger rhythm detection means). Therefore, detection of such a state of a finger could enable control of operation of an apparatus.

In addition, the finger movement detection means may make a comparison between a density value of the continuously input fingerprint image and a predetermined threshold. Thus, it may detect the travel distance or moving direction.

In addition, when the finger movement detection means may make a comparison between a density value of a fingerprint image and a predetermined threshold, it may continuously detect variation in the travel distance or moving direction of the finger by providing plural threshold. A plurality of thresholds could enable output of continuous finger movement. Thus, based on the output, the control information generation means could generate control information of an analog apparatus, even without preparing any special movable mechanism.

In addition, the finger movement detection means may continuously detect variation in the travel distance or moving direction of the finger by using a ratio between the region and “fingerprint area in the region” computed from each of the continuously input plural fingerprint images. If a travel distance or moving direction was detected by computing a ratio of area for continuous input, output of continuous finger movement could be obtained. And thus, based on the output, the control information generation means could generate control information of an analog apparatus, even without preparing a special movable mechanism.

In addition, the finger position detection means may detect a finger position by making a comparison between each density value of the plural fingerprint images input continuously and a predetermined threshold.

In addition, when the finger position detection means makes a comparison between a density value of the fingerprint image and a predetermined threshold, it may detect continuous information of a finger position by providing a plurality of thresholds. A plurality of thresholds could enable output of a continuous finger position. Thus, based on the output, the control information generation means could generate control information of an analog apparatus, even without preparing a special movable mechanism.

In addition, the finger position detection means may detect continuous information of a finger position by using a ratio between the region and “fingerprint area in the region” computed from each of the continuously input plural fingerprint images. Continuous output of finger area could be obtained if a ratio of an area were calculated from continuous inputs and a finger position detected. Thus, based on the output, the control information generation means could generate control information of an analog apparatus, even without preparing a special movable mechanism.

In addition, the finger contact area detection means may detect continuous information on the finger contact area by calculating a difference between each density value of fingerprint images input continuously and a density value when a finger is not placed. In such a configuration, output of contact area of a finger corresponding to continuous inputs could be obtained. Thus, based on the output, the control information generation means could generate control information of an analog apparatus even without preparing a special movable mechanism.

In addition, the state detection means may include at least two of the finger placement detection means, the finger release detection means, the finger movement detection means, the finger position detection means, the finger contact area detection means, and the finger rhythm detection means, and the control information generation means may generate the control information by integrating a plurality of detection results from the more than one means that the state detection means includes. Since the control information could be generated by integrated the more than one detection result, more complicated control information could be generated, thus enabling range of control of an apparatus to be widened.

In addition, an operating input program as other aspect of the present invention is an operation input program that causes a computer to execute a fingerprint image acquisition step of acquiring a fingerprint image, a state detection step of detecting state of a finger from the fingerprint images acquired in the fingerprint image acquisition step, and a control information generation step of generating control information of a device based on detection result in the state detection step, and is characterized in that the state detection step includes at least one of a finger placement detection step of detecting that a finger is placed when either a density value of an acquired fingerprint image or a difference in density values of plural acquired fingerprint images exceeds a predetermined threshold; a finger release detection step of detecting that a finger was released when either a density value of an acquired fingerprint image or a difference in density values of plural acquired fingerprint images falls below a predetermined threshold; a finger movement detection step of detecting travel distance or moving direction of a finger based on density values or area of plural fingerprint images continuously acquired from regions that have been divided in advance; a finger position detection step of detecting a finger position based on density values or fingerprint area of plural fingerprint images continuously acquired from regions that have been divided in advance; a finger contact area detection step of detecting contact area of a finger by calculating a difference between a density value when no finger is placed and that of an acquired fingerprint image; or a finger rhythm detection step of detecting rhythm of finger movement by either computing variation in fingerprint images input at predetermined time intervals or measuring time from finger placement to finger release.

The above-mentioned program obtains a fingerprint image, detects state of a finger from the fingerprint image, and generates control information of an apparatus based on the detection result. Therefore, it can operate an apparatus with only fingerprint images, without acquiring dedicated input information for operation of an apparatus. In addition, the state detection step includes at least one of the respective steps of: detecting whether or not a finger is placed (finger placement detection), whether the placed finger leaves or not (finger release detection), detecting a travel distance or moving direction of a finger (finger movement detection), detecting a position where a finger is placed (finger position detection), detecting a finger contact area (finger contact area detection), or detecting whether or not finger movement is in accordance with a certain rhythm (finger rhythm detection). Therefore, detecting such state of the finger could enable operation of an apparatus to be controlled.

In addition, the finger movement detection step may detect the travel distance or moving direction by making comparisons between each density value of the continuously acquired fingerprint images and a predetermined threshold.

In addition, in the finger movement detection step, when a comparison is made between the density value of the fingerprint image and a predetermined threshold in the finger movement detection step, variation in a travel distance or moving direction of a finger may be continuously detected by providing a plurality of the thresholds. The plurality of thresholds could enable output of the continuous finger movement as. Thus, based on the output, control information of an analog apparatus could be generated.

In addition, the finger movement detection step may continuously detect variation in a travel distance or moving direction of a finger by using a ratio between the region and “fingerprint area in the region” computed from each of the continuously input plural fingerprint images. Since output of continuous finger movement could be obtained by calculating a ratio of area for a plurality of fingerprint images acquired continuously and detecting a travel distance or moving direction, based on the output, control information of an analog apparatus could be generated.

In addition, the finger position detection step may detect a position of a finger by making comparisons between each density value of the plural fingerprint images acquired continuously and a predetermined threshold.

In addition, when a comparison is made between the density value of the fingerprint image and a predetermined threshold in the finger position detection step, continuous information of a finger position may be detected by providing a plurality of the thresholds. Since provision of the plurality of thresholds could enable output of the finger position as continuous quantity to be obtained, based on the output, control information of an analog apparatus could be generated.

In addition, the finger position detection step may detect continuous information of the finger position by using a ratio between the region and “fingerprint area in the region” computed from each of the continuously acquired plural fingerprint images. Output of continuous finger position could be obtained by computing a ratio of area for a plurality of fingerprint images acquired continuously and detecting a travel distance or moving direction. Therefore, based on the output, control information of an analog apparatus could be generated.

In addition, the finger contact area detection step may detect continuous information on the finger contact area by calculating a difference between each density value of the fingerprint images acquired continuously and a density value when no finger is placed. Output of finger contact area could be obtained by doing so for the plurality of fingerprint images acquired continuously. Therefore, based on the output, control information of an analog apparatus could be generated.

In addition, the state detection step may include at least 2 steps of the finger placement detection step, the finger release detection step, the finger position detection step, the finger contact area detection step, and the finger rhythm detection step, and the control information generation step may generate the control information by integrating detection results detected in more than one step that the state detection step includes. As integration of more than one detection result could generate control information, more complicated control information could be generated, thus enabling range of control of an apparatus to be widened.

### BEST MODE FOR CARRYING OUT THE INVENTION

In the following, we describe embodiments to which the present invention has been applied. First of all, with reference to the drawings, we describe a first embodiment wherein a portable phone has an operating input device of the present invention. The first embodiment is configured to output control information to a drive game with which a user enjoys virtual driving of a car on the portable phone, based on a fingerprint image acquired from a fingerprint sensor that is an input device. First, referring to FIG. 1 and FIG. 2 we describe configuration of the portable phone. FIG. 1 is an appearance drawing of the portable phone 1. FIG. 2 is a block diagram showing electrical configuration of the portable phone 1.

As shown in FIG. 1, the portable phone 1 is provided with a display screen 2, a ten-key input unit 3, a jog pointer 4, a call start button 5, a call end button 6, a microphone 7, a speaker 8, select buttons 9 and 10, a fingerprint sensor 11 as an input device, and an antenna 12 (See FIG. 2). In addition, a key input unit 38 (See FIG. 2) is comprised of the ten key input unit 3, jog pointer 4, call start button 5, call end button 6, and function select buttons 9, 10.

As far as a part and/to all of a fingerprint image of a finger can be obtained as fingerprint information, any type of the following sensors may be used for the fingerprint sensor 11: a sensor of capacitance type or an optical sensor, a sensor of thermosensitive type, electric field type, planar surface type, or line type.

As shown in FIG. 2, the portable phone 1 is provided with an analog front end 36 that amplifies an audio signal from a microphone 7 and voice to be output from a speaker 8, a voice codec unit 35 that converts the audio signal amplified by the analog front end 36 into a digital signal and a digital signal received from a modem 34 into an analog signal so that it can be amplified by the analog front end 36, a modem unit 34 that performs modulation and demodulation, and a sending/receiving unit 33 that amplifies and detects radio waves received from the antenna 12, modulates and amplifies a carrier signal with a signal received from the modem 34.

Furthermore, the portable phone 1 is provided with a controller 20 that controls the entire portable phone 1, the controller 20 having built-in CPU 21, RAM 22 for temporarily storing data, and clock function unit 23. The RAM 22 is to be used as a work area in processes to be described later. The RAM 22 has arranged storage areas such as an area for storing a fingerprint image to be obtained from the fingerprint sensor 11 and a density value thereof, and an area for storing results of detections carried out in the respective processes to be discussed later. In addition, to the controller 20 are connected a key entry unit 38, the display screen 2, the fingerprint sensor 11, a nonvolatile memory 30, and a melody generator 32. A speaker 37 for producing ring tone generated by the melody generator 32 is connected to the melody generator 32. The nonvolatile memory 30 is provided with an area for storing various programs to be executed by the CPU 21 of the controller 20, an area for storing initial settings such as a density value of the fingerprint sensor 11 when no finger is placed, an area for storing various predetermined thresholds, etc.

In the following, with reference to FIG. 3 to FIG. 9, we describe control of the drive game based on inputs from the fingerprint sensor 11 in the portable phone 1 that is configured as described above. FIG. 3 is a functional block diagram of this embodiment. FIG. 4 is a flowchart showing flow of a finger placement detection process. FIG. 5 is a flowchart showing flow of a finger release detection process. FIG. 6 is a pattern diagram of region splitting of the fingerprint sensor 11. FIG. 7 is a flowchart showing flow of a finger area detection process. FIG. 8 is a flowchart showing flow of a finger position detection process. FIG. 9 is a flowchart showing flow of a control information generation process.

As shown in FIG. 3, in this embodiment, a finger placement detection unit 51 repeatedly executes a finger placement detection process at predetermined time intervals to detect whether or not a finger has been placed on the fingerprint sensor and outputs detection result thereof to a control information generation unit 50. When the detection result of “the finger has been placed” is obtained from the finger placement detection unit, the control information generation unit 50 determines to start driving, and executes acquisition of detection results that will serve as a basis of accelerator control information and handle control information.

In parallel with the process of the finger placement detection unit 51, a finger area detection unit 52 repeatedly executes a process of calculating area of the finger placed on the fingerprint sensor 11 and of outputting it to the control information generation unit 50. Such calculation is made based on the detection result at the finger placement detection unit for small divided regions of the fingerprint sensor 11. A value of the calculated area shall be accelerator control information and transmitted to a game program 55 of the drive game, and thus control of vehicle speed shall be executed.

In addition, in parallel with the processes at the finger placement detection unit 51 or the finger area detection unit 52, a finger position detection unit 53 repeatedly executes a process of calculating a position of the finger on the fingerprint sensor 11 and of outputting it to the control information generation unit 50. Such calculation is made based on the detection result at the finger placement detection unit for the small divided regions of the fingerprint sensor 11. The position information shall be handle control information and transmitted to the game program 55 of the drive game, and thus control of steering angle shall be executed.

In addition, in parallel with the processes at the finger placement detection unit 51, the finger area detection unit 52, and the finger position detection unit 53, a finger release detection unit 54 repeatedly executes, at predetermined time intervals, a process of detecting whether or not “the finger placed on the fingerprint sensor 11” has been released, and outputs detection result thereof to the control information generation unit 50. When the detection result of “the finger has been released” is obtained from the finger release detection unit, the control information generation unit 50 outputs brake control information to the game program 55 and thus restraint control shall be executed.

The functional blocks in FIG. 3, namely, the finger placement detection unit 51, the finger area detection unit 52, the finger position detection unit 53, the finger release detection unit 54, and the control information generation unit shall be implemented by the hardware, namely, CPU 21 and each program.

In the following, referring to FIG. 4, we describe a finger placement detection process to be executed by the finger placement detection unit 51. The finger placement detection process is to detect whether or not a finger has been placed on the fingerprint sensor 11. The process is repeatedly executed at predetermined time intervals. The detection of finger placement shall be concurrently executed for every region that is a small divided region of the fingerprint sensor 11 (See FIG. 6). The detection result shall be used to detect contact area of a finger or a position of a finger, to be discussed later.

When the finger placement detection process begins, first, a density value of an image that serves as a reference is obtained (S1). As the reference image, for instance, a density value of the fingerprint sensor 11 of when no finger is placed that has been stored in advance in the nonvolatile memory 30 may be obtained. Then, a density value of an entered image on the fingerprint sensor 11 is obtained (S3). Then, a difference between the density value of the reference image obtained in S1 and that of the entered image is computed (S5). Next, it is determined whether or not the computed difference in the density values is greater than a predetermined threshold A (S7). Different values may be used as the threshold A, depending on the fingerprint sensor 11 or the portable phone 1. For instance, “50” can be used in the case of a density value in 256 tones.

If the difference in the density values is not greater than the threshold A (S7: NO), the process returns to S3 where a density value of an entered image on the fingerprint sensor 11 is obtained again. If the difference in the density values is greater than the threshold A (S7: YES), the finger placement is output (S9) and stored in the area of RAM 22 for storing the finger placement detection result. Then, the process ends.

In the above process, a difference between a density value of a reference image and that of an entered image is computed and a value of the difference is compared with a threshold. The density value of an entered image itself may be compared with a threshold, rather than using a reference image.

In the following, referring to FIG. 5, we describe a finger release detection process to be executed by the finger release detection unit 54. The finger release detection process is to detect whether or not “a finger that has been already placed on the fingerprint sensor 11” is released from the fingerprint sensor 11. The process is repeatedly executed at predetermined time intervals.

When the finger release detection process begins, first, a density value of a reference image is obtained (S11). As a reference image, for instance, a density value of the fingerprint sensor 11 of when no finger is placed that has been stored in advance in the nonvolatile memory 30 may be obtained. Next, a density value of an entered image on the fingerprint sensor 11 is obtained (S13). Then, a difference between the density value of the reference image obtained in S11 and that of the entered image is computed (S15). Next, it is determined whether or not the computed difference in the density values is smaller than a predetermined threshold B (S17). Different values may be used as the threshold B, depending on the fingerprint sensor 11 or the portable phone 1. For instance, “70” can be used in the case of a density value in 256 tones.

If the difference in the density values is not smaller than the threshold B (S7: NO), the process returns to S13 where a density value of an entered image on the fingerprint sensor 11 is obtained again. If the difference in the density values is smaller than the threshold B (S17: YES), finger release is output (S19) and stored in the area of RAM 22 for storing the finger release detection result. Then, the process ends.

In the above process, a difference between a density value of a reference image and that of an entered image is computed and a value of the difference is compared with a threshold. Similar to the finger placement detection process, the density value of an entered image itself may be directly compared with a threshold rather than using the reference image.

In the following, referring to FIG. 6 and FIG. 7, we describe a finger area detection process to take place in the finger area detection unit 52. As shown in FIG. 6, in this embodiment, the fingerprint sensor 11 of line type is divided into 3 small regions, a left region 61, a middle region 62, and a right region 63. The computation takes place assuming that a value of area of each small region is 1. The finger placement detection process and the finger release detection process described above are concurrently executed in the respective small regions. The results are acquired as status in the small regions, and finger contact area is computed based on this acquisition result. The number of small regions to be divided on the fingerprint sensor 11 shall not be limited to 3, but it may be divided into 5 or 7, etc. When the number of the small regions increases, more elaborate detection result can be obtained, thereby enabling generation of complicated control information. This embodiment assumes the fingerprint sensor 11 of line type. However, as described earlier, the fingerprint sensor to be used may be a sensor (area sensor) of planar surface type capable of acquiring an entire fingerprint image at once. In the case of the area sensor, it may be divided into 4 regions, top, bottom, left and right, or 9 regions of 3 in the vertical direction times 3 in the horizontal direction, for instance. The finger placement detection process and the finger release detection process may take place in each of such small regions to compute finger area.

In addition, finger state acquisition in these small regions may be sequentially processed by making the acquisition process of density values (S3 and S5 in FIG. 4 and S13 and S15 in FIG. 5) and the determination process based on the density values (comparison with thresholds: S7 in FIG. 4 and S17 in FIG. 15) a loop, in the flowcharts of FIG. 4 and FIG. 5. Or, the processes may be pipelined and concurrently processed.

As shown in FIG. 7, when the finger area detection process begins, first, state of respective small regions is obtained (S21). Then, it is determined whether or not finger placement is in a left region 61 (S23). If the finger placement is detected in the left region 61 (S23: YES), it is further determined whether or not the finger placement is in a middle region 62 (S25). If no finger placement is detected in the middle region (S25: NO), contact area of the finger will be “1” because the finger is placed only in the left region 61. Then, “1” is output as a value of the finger area, and stored in the area of RAM 22 for storing the finger area value (S27). Then, the process returns to S21.

If the finger placement is detected in the middle region (S25: YES), it is further determined whether the finger placement is in a right region 63 (S29). If no finger placement is detected in the right region 63 (S29: NO), the contact area of the fingers will be “2” because the fingers are placed in the left region 61 and the middle region 62. Then, “2” is output as a value of the finger area, and stored in the area of RAM 22 for storing the finger area value (S30). Then, the process returns to S21.

If the finger placement is detected in the right region 63 (S29: YES), the contact area of the fingers will be “3” because the fingers are placed in all the regions. Then, “3” is output as a value of the finger areas, and stored in the area of RAM 22 for storing the finger area value (S31). Then, the process returns to S21.

On the one hand, if no finger placement is detected in the left region 61 (S23: NO), it is then determined whether or not the finger placement is in the middle region 62 (S33). If no finger placement is detected in the middle region 62 (S33: NO), the finger is placed only in the right region 63 and the contact area of the finger shall be “1”. This is because finger placement is detected neither in the left region 61 nor in the middle region 62 although the finger placement is detected for the entire fingerprint sensor 11. Thus, “1” is output as a value of the finger area and stored in the area of RAM 22 for storing the finger area value (S35). Then, the process returns to S21.

If the finger placement is detected in the middle region 62 (S33: YES), it is further determined whether or not the finger placement is further in the right region 63 (S37). If no finger placement is detected in the right region 63 (S37: NO), the finger is placed only in the middle region 62, and thus the contact area of the finger will be “1”. Thus, “1” is output as the finger area value and stored in the area of RAM 22 for storing the finger area value (S35). Then, the process returns to S21.

If the finger placement is detected in the right region 63 (S37: YES), the finger is placed in the middle region 62 and the right region 63, the contact area of the finger will be “2”. Then, “2” is output as a value of the finger area and stored in the area of RAM 22 for storing the finger area value (S39). Then, the process returns to S21.

Repeated execution of the above processes could achieve sequential computation of contact area of a finger placed on the fingerprint sensor 11. Then, the computation result is stored in the area of RAM 22 for storing the finger area value. Then the result is read out in a control information generation process to be described later, and utilized as basic information for generating control information.

In the following, referring to FIG. 8, we describe the finger position detection process to be executed at the finger position detection unit 53. In the finger position detection process, similar to the finger area detection process, the fingerprint sensor 11 is divided into 3 small regions, a left region 61, a middle region 62, and a right region 63 as shown in FIG. 6. The detection results of the finger placement detection process and the finger release detection process being concurrently executed in the respective small regions. The results are acquired as state of the small regions and a current position of the finger is detected based on the acquired results. Similar to the finger area detection process, the number of small regions to be divided on the fingerprint sensor 11 shall not be limited to 3, but it may be divided into 4 or 9 regions by using the area sensor and then the finger position detection may take place.

As shown in FIG. 8, when the finger position detection process begins, first, state of respective small regions is obtained (S41). Then, it is determined whether or not finger placement is in a left region 61 (S43). If the finger placement is detected in the left region 61 (S43: YES), it is further determined whether or not the finger placement is in a middle region 62 (S45). If no finger placement is detected in the middle region 62 (S45: NO), the finger position will be left end because the finger is placed only in the left region 61. Then, the left end is output as the finger position and stored in the area of RAM 22 for storing the finger position (S47). Then, the process returns to S41.

If the finger placement is detected in the middle region (S45: YES), it is further determined whether the finger placement is in a right region 63 (S49). If no finger placement is detected in the right region 63 (S49: NO), the finger position will be close to left than the center because the fingers are placed in the left region 61 and the middle region 62. Then, “left” is output as the finger position and stored in the area of RAM 22 for storing the finger position (S50). Then, the process returns to S41.

If the finger placement is detected in the right region (S49: YES), the finger is positioned almost at the center because the fingers are placed in all the regions. Then, the “center” is output as the finger position and stored in the area of RAM 22 for storing the finger position (S51). Then, the process returns to S41.

On the one hand, if no finger placement is detected in the left region 61 (S43: NO), it is then determined whether or not the finger placement is in the middle region 62 (S53). If no finger placement is detected in the middle region 62 (S53: NO), the finger is placed only in the right region 63 and the finger position will be right end. This is because the finger placement is detected neither in the left region 61 nor in the middle region although the finger placement is detected for the entire fingerprint sensor 11. Thus, “right end” is output as the finger position and stored in the area of RAM 22 for storing the finger position (S55). Then, the process returns to S41.

If the finger placement is detected in the middle region 62 (S53: YES), it is further determined whether or not the finger placement is further in the right region 63 (S57). If the finger placement is detected in the right region 63 (S57: YES), the finger position will be closer to right than the center because the fingers are placed in the middle region 62 and the right region 63. Then, “right” is output as the finger position and stored in the area of RAM 22 for storing the finger position (S59). Then, the process returns to S41.

If no finger placement is detected in the right region 63 (S57: NO), the finger position will be the center because the finger is placed only in the middle region 62. Then, “center” is output as the finger position and stored in the area of RAM 22 for storing the finger position (S51). Then, the process returns to S41.

Repeated execution of the above process could enable sequential detection of the finger position placed on the fingerprint sensor 11. In addition, if the number of divided regions is increased, more detailed position information can be obtained. Then, the detection result is stored in the area of RAM 22 for storing the finger position. And the result is read out in the control information generation process to be described later, it will be utilized as basic information for generating control information.

In the following, referring to FIG. 9, we describe the control information generation process to be executed at the control information generation unit 50. The control information generation process is to obtain information on state of a finger placed on the fingerprint sensor 11, and to output, based thereon, accelerator control information, handle control information and brake control information for controlling the drive game program.

First, as shown in FIG. 9, the finger placement detection result of the entire fingerprint sensor 11 is obtained (S61). Then, it is determined whether or not the obtained finger placement detection result shows the finger placement (S63). If it shows no finger placement (S63: NO), the process returns to S61 where the finger placement detection result is obtained again.

If there is the finger placement (S63: YES), the latest finger area value output by the finger area detection process and stored in RAM 22 is obtained (S65). Then, the accelerator control information is output to the game program based on the obtained value of the finger area (S67). If the finger area value is high, information is output requesting the accelerator to be pressed strongly

Then, the latest finger position information output by the finger position detection process and stored in RAM 22 is obtained (S69). Then, handle control information is output to the game program based on the obtained finger position (S71). Information for determining a steering angle is output based on the finger position.

Then, the finger release detection result is obtained (S73). Then, it is determined whether or not the obtained finger release detection result shows the finger release (S75). If there is no finger release (S75: NO), it is determined that the drive game will continue. Then, the process returns to S65 where a value of the finger area is obtained again and control information to the game program is generated.

If there is the finger release (S75: YES), brake control information for stopping the driving is output to the game program (S77). The above process could generate information for controlling how the game progresses and operate the game, based on the detection result of state of the finger placed on the fingerprint sensor 11 (whether the finger is placed or released, where the finger is positioned, how much it contacts).

In the finger area detection process and the finger position detection process in the first embodiment described above, individual detection results of a value of finger area and a finger position are output as a discrete value. The finger contact area or finger position can also be output as continuous information. If generation of analog continuous information is desired, such as the drive game as described above, the output of continuous information may be preferable, in particular. This could enable execution of control with continuous information without relying on such a special analog input device as a joystick. Thus, in the following, we describe a second embodiment wherein such continuous amount is output. As configuration of the second embodiment is similar to that of the first embodiment, description of the latter shall be incorporated herein. In addition, as for the control processes, only a finger area detection process and a finger position detection process that are different from those of the first embodiment are described with reference to FIG. 10 to FIG. 12. For the other processes, the description of the first embodiment shall be incorporated herein. FIG. 10 is a pattern diagram of region splitting of the fingerprint sensor 11 in the second embodiment. FIG. 11 is a flowchart of the finger area detection process in the second embodiment. FIG. 12 is a flowchart of the finger position detection process in the second embodiment.

As shown in FIG. 10, in the second embodiment, the fingerprint sensor 11 of line type is divided into a 2 small regions, left region 71 and a right region 72. A density value of a fingerprint image is obtained in each small region, and the state of a finger is determined by comparing 2 thresholds with the density values in each region. In this embodiment, thresholds TH1 and TH2 of the left region are 150 and 70, while thresholds TH3 and TH4 of the right region 72 are 150 and 70. Based on the state of a finger, contact area of the finger is computed, and a position of the finger is determined. Thus, outputting continuous information is possible by comparing density values with a plurality of thresholds and using comparison result thereof when state of each small region is determined.

First, with reference to FIG. 11, we describe a finger area detection process which continuously output “contact area” of a finger. First, a density value of a fingerprint image in each small region is obtained (S81). Then, it is determined whether or not the density value of the obtained left region 71 is greater than a threshold TH1 (150) (S83). Being greater than the threshold TH1 shows the condition in which density of a fingerprint image is high, i.e., the finger is firmly placed in the left region 71. If it is greater than the threshold TH1 (S83: YES), it is then determined whether the density value of the right region 72 is also greater than TH3 (150) (S85). If the density is higher than TH3 (S85: YES), “4” is output as a value of the finger area because the finger is firmly placed on the entire fingerprint sensor 11, and stored in the area of RAM 22 for storing the finger area values (S87). Then, the process returns to S81 where an image of each small region is acquired again.

If the density value of the left region 71 is greater than TH1 (S83: YES) but that of the right region 72 has not yet reached TH3 (S85: NO), it is further determined whether a density value of the right region 72 is higher than TH4 (70) (S89). If the density value is greater than TH4 although it is less than TH3, it means state in which the finger is about to be placed or released, meaning that the finger is in contact to some degree. Then, if it is greater than TH4 (S89: YES), “3” is output as the finger area value and stored in RAM 22 (S91). Then, the process returns to S81 where an image of respective small regions is obtained. If the density value of the right region 72 has not reached TH4 (S89: NO), “2” is output as the finger area value because it seems that the finger does not touch the right region 72, and stored in the area of RAM 22 for storing the finger area value (S93). Then, the process returns to S81 where an image of each small region is obtained again.

If the density value of the left region 71 has not reached TH1 (S83: NO), it is then determined whether or not the density value of the left region 71 is greater than TH2 (70) (S95). If the density value is less than TH1 but greater than TH2, it means state in which the finger is being placed or released, and state in which it contacts to some extent. Then, if it is greater than TH2 (S95: YES), it is further determined for the right region 72 whether the density value is greater than TH3 (150) (S97). If the density value is greater than TH3 (S97: YES), “3” is output as a value of the finger area and stored in the area of RAM 22 for storing the finger area value (S91), because the finger slightly contacts the left region 71 and firmly contacts the right region 72. Then, the process returns to S81 where an image of each small region is obtained again.

If the density value of the left region 71 is less than TH1 (S83: NO) and greater than TH2 (S95: YES), and that of the right region 72 is less than TH3 (S97: NO), it is further determined whether or not the density value of the right region 72 is greater than TH4 (S99). If the density value of the right region 72 is greater than TH4 (S99: YES), “2” is output as a value of the finger area and stored in RAM 22 (S101) because the finger slightly touches both the left region 71 and the right region 72. Then, the process returns to S81 where an image of each small region is obtained. If the density value of the right region 72 is less than TH4 (S99: NO), “1” is output as a value of the finger area and stored in the area of RAM 22 for storing the finger area value (S103) because no finger touches the right region 72. Then, the process returns to S81 where an image of each small area is obtained.

If the density value of the left region 71 is less than TH2 (S95: NO), then, determination is made on the density value of the right region 72 because the finger does not touch the left region. First, it is determined whether or not the density value of the right region 72 is greater than the threshold TH3 (S105). If it is greater than TH3 (S105: YES), “2” is output as a value of the finger area and stored in the area of RAM 22 for storing the finger area value (S101), because the finger does not touch the left region 71 while it firmly touches the right region 72. Then, the process returns to S81 where an image of each small region is obtained again.

If the density value of the left region 71 is less than TH2 (S95: NO) and that of the right region 72 is less than TH2 (S105: NO), it is further determined whether or not the density value of the right region 72 is greater than TH4 (S107). If it is greater than TH4 (S107: YES), 1 is output as a value of the finger area and stored in the area of RAM 22 for storing the finger area value (S109). Then, the process returns to S81 where an image of each small region is obtained again.

If the density value of the left region 71 is less than TH2 (S95: NO) and that of the right region 72 is also less than TH4 (S105: N0, S107: NO), “0” is output as a value of the finger area and stored in the area of RAM 22 of storing the finger area value (S111), because the finger seems not to touch the fingerprint sensor 11. Then, the process returns to S81 where an image of each small region is obtained.

With the finger area detection process described above, a value of the finger area is output as 0 to 4. Sequential repetition of the finger area detection process could output degree of finger contact as continuous values. Thus, if accelerator control information is generated based on this finger area value in the control information generation process, smooth control such as “gradually increasing amount of pressing the accelerator” or “gradually decreasing amount of pressing the accelerator” is possible. In addition, if the number of thresholds is further increased, the area value in higher phases could be output, thereby enabling smooth control.

In addition, in the finger area detection process described above, continuous values of the finger area could be obtained by providing a plurality of thresholds for the respective small regions. And, it would also be possible to determine finger area by summing the proportions of the area on which the finger is placed. For instance, assume that the entire area of the left region 71 is 100 and area A on which the finger is placed is 50. Then, assume that the area of the right region 72 is 100, out of which area B where the finger is placed is 30. The values of the finger area in this case, can be determined with S=A+B, thus being 50+30=80. Sequential determination of the finger area with such expressions could achieve acquisition of the continuous finger area values.

In the following, with reference to FIG. 12, we describe the finger position detection process which detects a position of a finger as continuous value. First, a density value of a fingerprint image in each small region is obtained (S121). Then, it is determined whether or not the obtained density value of a left region 71 is greater than a threshold TH1 (150) (S123). Being greater than the threshold TH1 indicates that a finger is firmly placed in the left region 71. If it is greater than the threshold TH1 (S123: YES), it is then determined whether or not the density value of a right region 72 is greater than a threshold TH3 (150) (S125). If the density value is greater than TH3 (S125: YES), “center” is output as a position of the finger and stored in RAM 22 (S127) because it indicates that the finger is firmly placed throughout the fingerprint sensor 11 without being biased. Then, the process returns to S121 and an image of each small region is obtained.

If the density value of the left region 71 is greater than TH1 (S123: YES) but that of the right region 72 has not yet reached TH3 (S125: NO), it is further determined whether or not the density value of the right region 72 is greater than TH4 (70) (S129). As far as the density value is greater than TH4 although it is less than TH3, the finger is about to be placed or released, meaning that it is in contact to some degree. Thus, if the density value is greater than TH4 (S129: YES), it is determined that the finger is somewhat biased to the left, and “left” is output as the finger position and stored in RAM 22 (S131). Then, the process returns to S121 where an image in each small region is obtained. If the density value of the right region 72 has not reached TH4 (S129: NO), “left end” is output as the finger position and stored in RAM 22 (S133) because it is considered that the finger is hardly in touch with the right region 72 and biased to the left. Then, the process returns to S121 where an image in each small region is obtained.

If the density value of the left region 71 has not reached TH1 (S123: NO), it is then determined whether or not the density value of the left region 71 is greater than TH2 (70) (S135). As far as the density value is greater than TH2 although it is less than TH1, the finger is about to be placed or released, meaning that it is in contact to some degree. Then, if it is greater than TH2 (S135: YES), it is further determined whether or not the density value of the right region 72 is greater than TH3 (150) (S137). If the density value is greater than TH3 (S137: YES), “right” is output as the finger position and stored in RAM 22 (S139) because it is considered that the finger is slightly in touch with the left region 71 and firmly in touch with the right region 72, and thus the finger is biased to the right. Then, the process returns to S121 where an image of each small region is obtained.

If the density value of the left region 71 is less than TH1 (S123: NO) and greater than TH2 (S135: YES), and that of the right region 72 is less than TH3 (S137: NO), it is further determined whether or not the density value of the right region 72 is greater than TH4 (S141). If the density value of the right region 72 is greater than TH4 (S141: YES), “center” is output as the finger position and stored in RAM 22 (S143) because the finger is slightly in touch with both the left region 71 and the right region 72 without being biased to either direction. Then, the process returns to S121 where an image in each small region is obtained. If the density value of the right region 72 is less than TH4 (S141: NO), “left” is output as the finger position and stored in RAM 22 (S145) because the finger is not in touch with the right region 72 and biased to the left. Then, the process returns to S121 where an image in each small region is obtained.

If the density value of the left region 71 is less than TH2 (S135: NO), the finger is not in touch with the left region 71, and then determination is to be made on the density value of the right region 72. First, it is determined whether or not the density value of the right region 72 is greater than TH3 (S147). If it is greater than TH3 (S147: YES), “right end” is output as the finger position and stored in RAM 22 (S149) because the finger is firmly in touch with the right region 72 while it is not in touch with the left region 71 and the finger is rather biased to the right. Then, the process returns to S121 where an image in each small region is obtained.

If the density value of the left region 71 is less than TH2 (S135: NO) and that of the right region is less than TH3 (S147: NO), it is further determined whether or not the density value of the right region 72 is greater than TH4 (S151). If it is greater than TH4 (S151: YES), “right” is output as the finger position and stored in RAM 22 (S153) because the finger is slightly in touch with the right region 72 while it is not in touch with the left region 71. Then, the process returns to S121 where an image in each small region is obtained.

If the density value of the left region 71 is less than TH2 (S135: NO) and that of the right region 72 is also less than TH4 (S147: N0, S151: NO), “center” is output as the finger position and stored in RAM 22 (S155) because the finger placement is determined throughout the fingerprint sensor 11 although the finger is hardly in touch with the fingerprint sensor 11. Then, the process returns to S121 where an image in each small region is obtained.

With the above finger position detection process, the finger position is output in 5 phases of left end, left, center, right and right end. Sequentially repeating the finger area detection process could enable a finger position to be output as a continuous value. Thus, smooth control such as gradually increasing or decreasing an angle of turning a steering wheel becomes possible if handle control information is generated based on this finger positions in the control information generation process described above. In addition, if the number of thresholds is further increased, a finger position can be detected in a greater number of phases, thereby enabling generation of detailed control information.

In the above finger position detection process, continuous information on a finger position can be obtained by providing a plurality of thresholds for each small region. A finger position can be determined through the use of the ratio of area where a finger is placed to area of each small region. In this case, the center is expressed as 0, left as a negative value, and right as a positive value. For instance, assume that the total area of the left region 71 is 100 and the area A thereof where the finger is placed is 50. Then, assume that the area of the right region 72 is 100 and the area B thereof where the finger is placed is 30. The finger position X in this case can be determined with X=B−A, i.e., 30−50=−20, meaning that the finger is somewhat (20%) biased to the left. Sequential determination of a finger position with such a numeric expression could enable detection of continuous finger positions.

Then, in the operating input process for controlling the above drive game, information from the finger position detection unit 53 on a finger position on the fingerprint sensor 11 is used as a basis for the control information generation unit 50 to generate handle control information. However, information on movement of a finger can be alternatively used instead of the information on the finger position. Now in the following, we describe a third embodiment wherein a finger movement detection unit (not shown) is provided instead of the finger position detection unit as shown in FIG. 3. Since configuration of the third embodiment and any processes other than the process of detecting finger movement instead of the finger position detection are similar to those of the first embodiment, the description of the latter is incorporated herein. Then, we describe the finger movement detection process with reference to FIG. 13. FIG. 13 is a flowchart showing flow of the finger movement detection process.

As shown in FIG. 13, in the finger movement detection process, state of each small region is first obtained for left/middle/right small regions 61 to 63 (see FIG. 6) that are 3 divisions of the fingerprint sensor 11 of line type (S161). Similar to the first embodiment, the state is acquired by obtaining output result of the finger placement detection process being concurrently executed in respective small regions.

Then, it is determined whether or not the obtained output result show finger placement in all regions (S163). If the finger placement is present in all regions (S163: YES), “A” is made a reference position for determination of finger movement and stored in RAM 22 (S165). The reference position should be stored twice so that in a process to be discussed later, finger movement is detected by comparing a last reference position with a current reference position. Then, the last reference position is retrieved from RAM 22, thereby determining on movement (S167 to S179). Since no last reference position is stored for a first time (IS167: N0, S171: N0, S175: NO), “no shift” is output (S179) and the process returns to S161.

In the second process or later, if there is the finger placement in all regions (S163: YES), “A” is made a reference position (S165) and it is determined whether or not a last reference position is A (S167). If the last reference position is “A” (S167: YES), “no shift” is output (S169) because it is identical to the current reference position, and the process returns to S161.

If the last reference position is not “A” (S167: NO), it is determined whether or not the last reference position is “B” (S171). The reference position “B” is output (S183) if it is determined that the finger placement is in both the left region 61 and the middle region 62 (S181: YES), which is to be discussed later. If the last reference position is “B” (S171: YES), “Shift to right” is output (S173) because the finger position was shifted from left to the center, and the process returns to S161.

If the last reference position is not B (S171: NO), it is determined whether or not the last reference position is C (S175) The reference position “C” is output (S201) if it is determined that the finger placement is in both the right region 63 and the middle region 62 (S199: YES) If the last reference position is “C” (S175: YES), “Shift to left” is output (S177) because the finger position was shifted from right to the center, and the process returns to S161.

If the last reference position is not “C” (S175: NO), “No shift” is output (S179) in this case because either the last reference position was not stored (for the first-time process) or the last reference position was “D”, and the process returns to S161.

If no finger placement is determined in all regions (S163: NO), it is then determined whether or not the finger placement is in both the left region 61 and the middle region 62 (S181). If the finger placement is determined in both left and middle small regions (S181: YES), “B” is made a reference position for determining on finger movement and stored in RAM 22 (S183). Next, it is determined whether or not the last reference position is A (S185). If the last reference position is “A” (S185: YES), “Shift to left” is output (S187) because the finger position was shifted from the center to left and the process returns to S161.

If the last reference position is not “A” (S185: NO), it is determined whether or not the last reference position is “B” (S189). If the last reference position is “B” (S189: YES), “No shift” is output (S191) because the last and current reference positions are identical, and the process returns to S161.

If the last reference position is not “B” (S189: NO), it is determined whether the last reference position is “C” (S193). If the last reference position is “C” (S193: YES), “Major shift to left” is output (S195) because the finger position was considerably changed from right to left, and the process returns to S161.

If the last reference position is not “C” (S193: NO), “No shift” is output in this case (S197) because either the last reference position was not stored (for the first-time process) or the last reference position was “D”. Then, the process returns to S161.

If no finger placement is determined not only in all regions (S163: NO) but also in both the left and middle small regions (S181: NO), it is determined whether or not the finger placement is determined in both the right region 63 and the middle region 62 (S199). If the finger placement is determined in both the right and middle small regions (S199: YES), “C” is made a reference position for determining on finger movement and stored in RAM 22 (S201). Then, it is determined whether or not the last reference position is “A” (S203). If the last reference position is A (S203: YES), “Shift to right” is output (S205) because the finger position was shifted from the center to right, and the process returns to S161.

If the last reference position is not “A” (S203: NO), it is determined whether or not the last reference position is “B” (S207). If the last reference position is “B” (S207: YES), “Major shift to right” is output (S209) because the finger position was considerably changed from left to right, and the process returns to S161.

If the last reference position is not “B” (S207: NO), it is determined whether or not the last reference position is “C” (S211). If the last reference position is “C” (S211: YES), “No shift” is output (S213) because the current and last reference positions are identical, and the process returns to “S161”.

If the last reference position is not “C” (S211: NO), “No shift” is output in this case because either the last reference position was not stored (for the first-time process) or the last reference position is “D”, and the process returns to S161.

In the case that no finger placement is determined in all regions (S163: NO) as well as in both the left and middle small regions (S181: NO) and in both the right and middle small regions (S199: NO), the case is classified as others and stored as reference position “D” in RAM 22 (S215). Then, if the reference position is D, “No shift” is output (S217) irrespective of the last reference position, and the process returns to S161.

With the finger movement detection process described above, finger movement is output in the form of “Major shift to left”, “Shift to left”, “Shift to right”, “Major shift to right”, and “No shift”. Then, based on them, in the control information generation process, handle control information such as “Widely steer left”, “Turn a wheel left”, “Turn a wheel right”, “Widely steer right”, “No handle operation”, etc. is generated and output to the game program.

Although the finger movement detection process in the above third embodiment is discrete output, similar to the second embodiment descried earlier, provision of a plurality of thresholds in the finger placement detection or use of the contact area ratio could enable acquisition of continuous outputs in the finger movement detection as well. In the following, with reference to FIG. 14 to FIG. 19 we describe a fourth embodiment wherein the finger movement detection for obtaining continuous outputs is executed. FIG. 14 is a flowchart of the finger movement detection process for obtaining continuous outputs. FIG. 15 is a flowchart of a subroutine in the case of the “reference position A” to be executed in S227 and S243 of FIG. 14. FIG. 16 is a flowchart of a subroutine in the case of the “reference position B” to be executed in S231 of FIG. 14. FIG. 17 is a flowchart of a subroutine in the case of the “reference position C” to be executed in S233 and S245 of FIG. 14. FIG. 18 is a flowchart of a subroutine in the case of the “reference position D” to be executed in S239 and S253 of FIG. 14. FIG. 19 is a flowchart of a subroutine in the case of the “reference position E” to be executed in S239 of FIG. 14.

In the fourth embodiment, similar to the second embodiment, the fingerprint sensor 11 of line type is divided into 2 small regions, i.e., a left region 71 and a right region 72 (See FIG. 10), wherein a density value of a fingerprint image is obtained in each small region, the density values are compared with 2 thresholds (In this embodiment, thresholds TH1 and TH2 of the left region 71 are 150 and 70, while thresholds TH3 and TH4 of the right region 72 are 150 and 70) in the respective regions, thus detecting finger movement.

As shown in FIG. 14, when the finger movement detection process begins, density values of fingerprint images are obtained in respective small regions (S221). Then, it is determined whether or not the acquired density value of the left region 71 is greater than the threshold TH1 (150) (S223). Being greater than the threshold TH1 indicates that a finger is firmly placed within the left region 71. If it is greater than the threshold TH1 (S223: YES), it is then determined whether the density value of the right region 72 is also greater than TH3 (150) (S225). If the density value is greater than TH3 (S225: YES), the finger is firmly placed throughout the fingerprint sensor 11 without being biased. Then, “A” is made a reference position for determination on finger movement, and the process moves to a subroutine of the reference position “A” that determines on the finger movement through comparison with the last reference position (S227). Now, similar to the third embodiment, a reference position should be stored twice, and is to detect any finger movement by comparing a last reference position and a current reference position. When the subroutine at the reference position “A” ends, the process returns to S221 where an image in each small region is obtained. We later describe the subroutine at the reference position “A”, referring to FIG. 15.

If the density value of the right region 72 has not yet reached TH3 (S225: NO) while the density value of the left region 71 is greater than TH1 (S223: YES), it is further determined whether or not the density value of the right region 72 is greater than TH4 (70) (S229). If the density value is less than TH3 but greater than TH4, it indicates that the finger is about to be placed or released, meaning that it is in contact to some degree. If the density value of the right region 72 has not reached TH4 (S229: NO), “B” is made a reference position for determining finger movement because it is considered that the finger is hardly in touch with the right region 72 and biased to left, and the process moves to a subroutine of the reference position “B” for determining finger movement through comparison with the last reference position (S231). If the subroutine at the reference position B ends, the process returns to S221 where an image in each small region is obtained. We later describe the subroutine at the reference position “B”, referring to FIG. 16.

If the density value of the right region 72 is greater than TH4 (S229: YES), “C” is made a reference position for determining finger movement, and the process moves to a subroutine at the reference position “C” for determining the finger movement through comparison with the last reference position (S233). When the subroutine at the reference position “C” ends, the process returns to S221 where an image in each small region is obtained. We later describe the subroutine at the reference position “C”, referring to FIG. 17.

If the density value of the left region 71 has not reached TH1 (S223: NO), it is then determined whether or not the density value of the left region 71 is greater than TH2 (70) (S235). If the density value is less than TH1 but greater than TH2, it indicates that the finger is about to be placed or released, meaning that it is in contact to some degree. Then, if it is greater than TH2 (S235: YES), it is further determined whether or not the density value of the right region 72 is greater than TH3 (150) (S237). If the density value is greater than TH3 (S237: YES), it is considered that the finger is biased to right because the finger is slightly in touch with the left region 71 and firmly in touch with the right region 72. Thus, “D” is made a reference position for determining the finger movement, and the process moves to a subroutine at the reference position “D” for determining on the finger movement through comparison with the last reference position (S229). When the subroutine at the reference position “D” ends, the process returns to S221 where an image in each small region is obtained. We later describe the subroutine at the reference position “D”, referring to FIG. 18.

If the density value of the left region 71 is less than TH1 (S223: NO) and greater than TH2 (S235: YES), and that of the right region 72 is less than TH3 (S237: NO), it is further determined whether or not the density value of the right region 72 is greater than TH4 (S241). If the density value of the right region 72 is greater than TH4 (S241: YES), the finger is slightly in touch with both the left region 71 and the right region 72 without being biased. Thus, “A” is made a reference position for determining the finger movement, and the process moves to the subroutine at the reference position A for determining the finger movement through comparison with the last reference position (S243). When the subroutine at the reference position “A” ends, the process returns to S221 where an image in each small region is obtained.

If the density value of the right region 72 is less than TH4 (S241: NO), the finger is not in touch with the right region and biased to left. Thus, “C” is made a reference position for determining the finger movement, and the process moves to a subroutine at the reference position “2C” for determining on the finger movement through comparison with the last reference position (S245). When the subroutine at the reference position C ends, the process returns to S221 where an image of each small region is obtained.

If the density value of the left region 71 is less than TH2 (S235: NO), the finger is not in touch with the left region 71, and then determination on the density value of the right region 72 takes place. First, it is determined whether or not the density value of the right region 72 is greater than the threshold TH3 (S247). If it is greater than TH3 (S247: YES), the finger is firmly in touch with the right region 72 while it is not in touch with the left region 71, and it is substantially biased to right. Hence, “E” is made a reference position for determining the finger movement, and the process moves to a subroutine at the reference position “E” for determining on the finger movement through comparison with the last reference position (S249). When the subroutine at the reference position E ends, the process returns to S221 where an image in each small region is obtained. We later describe the subroutine at the reference position “E”, referring to FIG. 19.

If the density value of the left region 71 is less than TH2 (S235: NO) and that of the right region is less than TH3 (S247: NO), it is further determined whether or not the density value of the right region 72 is greater than TH4 (S251). If it is greater than TH4 (S251: YES), the finger is slightly in touch with the right region 72 while it is not in touch with the left region 71. Thus, “D” is made a reference position for determining the finger movement, and the process moves to a subroutine at the reference position “D” for determining on the finger movement through comparison with the last reference position (S253). When the subroutine at the reference position “D” ends, the process returns to S221 where an image in each small region is obtained.

If the density value of the left region 71 is less than TH2 (S235: NO) and that of the right region 72 is also less than TH4 (S247: N0, S251: NO), they are classified as other cases with Fas a reference position and stored in RAM 22 (S255). Then, when the reference position is “F”, “No shift” is output (S257) irrespective of the last reference position. Then, the process returns to S221 where an image in each small region is obtained.

In the following, with reference to FIG. 15, we describe the finger movement determination process when the reference position is “A”. When processing of a subroutine begins, first, “A” is made a reference position for determining the finger movement and stored in RAM 22 (S261). Next, the last reference position is retrieved from RAM 22, thereby determining the movement. It is first determined whether or not the last reference position is “A” (S263). If the last reference position is A (S263: YES), “No shift” is output (S265) because the current and the last reference positions are identical, and the process returns to the finger movement detection process routine of FIG. 14.

If the last reference position is not “A” (S263: NO), then it is determined whether or not the last reference position is B (S267). As described earlier, the reference position “B” is output when the density value of the left region 71 is greater than the threshold TH1 and that of the right region 72 is less than the threshold TH4. Thus, if the last reference position is “B” (S267: YES), “Shift to right” is output (S269), and the process returns to the finger movement detection process routine of FIG. 14.

If the last reference position is not “B” (S267: NO), it is determined whether or not the last reference position is “C” (S271). As described earlier, the reference position “C” is output either when the density value of the left region 71 is greater than the threshold TH1 and that of the right region 72 is less than the threshold TH3 and greater than TH4, or when the density value of the left region 71 is less than the threshold TH1 and greater than TH2, and that of the right region 72 is less than the threshold TH4. Thus, if the last reference position is “C” (S271: YES), “Minor shift to right” is output (S273), and the process returns to the finger movement detection process routine of FIG. 14.

If the last reference position is not “C” (S271: NO), it is determined whether or not the last reference position is “D” (S275). As described earlier, the reference position D is output either when the density value of the left region 71 is less than the threshold TH1 and greater than TH2 and that of the right region 72 is greater than the threshold TH3, or when the density value of the left region 71 is less than the threshold TH2 and that of the right region 72 is less than the threshold TH3 and greater than TH4. Thus, if the last reference position is D (S275: YES), “Minor shift to left” is output (S277), and the process returns to the finger movement detection process routine of FIG. 14.

If the last reference position is not “D” (S275: NO), it is determined whether or not the last reference position is “E” (S279). As described earlier, the reference position “E” is output when the density value of the left region 71 is less than the threshold TH2 and that of the right region 72 is greater than the threshold TH3. Thus, if the last reference position is E (S279: YES), “Shift to left” is output (S281), and the process returns to the finger movement detection process routine of FIG. 14.

If the last reference position is not “E” (S279: NO), “No shift” is output (S283) because either the last reference position was not stored (for the first-time process) or the last reference position was “F”, and the process returns to the finger movement detection process routine of FIG. 14.

In the following, with reference to FIG. 16, we describe the finger movement determination process when the reference position is “B”. When processing of a subroutine begins, first, B is made a reference position for determining the finger movement and stored in RAM 22 (S291). Then, the last reference position is retrieved from RAM 22, thereby determining the movement. It is first determined whether or not the last reference position is “A” (S293). As described earlier, the reference position “A” is output either when the density value of the left region 71 is greater than the threshold TH1 and that of the right region 72 is greater than the threshold TH3, or when the density value of the left region 71 is less than the threshold TH1 and greater than TH2 and that of the right region 72 is less than the threshold TH3 and greater than TH4. Thus, if the last reference position is “A” (S293: YES), “Shift to left” is output (S295), and the process returns to the finger movement detection process routine of FIG. 14.

If the last reference position is not “A” (S293: NO), it is determined whether or not the last reference position is “B” (S297). If the last reference position is “B” (S297: YES), “No shift” is output (S299) because the current and the last reference positions are identical, and the process returns to the finger movement detection process routine of FIG. 14.

If the last reference position is not “B” (S297: NO), it is determined whether or not the last reference position is C (S301). As described earlier, the reference position C is output either when the density value of the left region 71 is greater than the threshold TH1 and that of the right region 72 is less than the threshold TH3 and greater than TH4, or when the density value of the left region 71 is less than the threshold TH1 and greater than TH2 and that of the right region 72 is less than the threshold TH4. Thus, if the last reference position is C (S301: YES), “Minor shift to left” is output (S303), and the process returns to the finger movement detection process routine of FIG. 14.

If the last reference position is not “C” (S301: NO), it is determined whether or not the last reference position is “D” (S305). As described earlier, the reference position “D” is output either when the density value of the left region 71 is less than the threshold TH1 and greater than TH2 and that of the right region 72 is greater than the threshold TH3, or when the density value of the left region 71 is less than the threshold TH2 and that of the right region 72 is less than the threshold TH3 and greater than TH4. Thus, if the last reference position is “D” (S305: YES), “Major shift to left” is output (S307), and the process returns to the finger movement detection process routine of FIG. 14.

If the last reference position is not “D” (S305: NO), it is determined whether or not the last reference position is “E” (S309). As described earlier, the reference position “E” is output when the density value of the left region 71 is less than the threshold TH2 and that of the right region 72 is greater than the threshold TH3. Thus, if the last reference position is E (S309: YES), “Major-Major shift to left” is output (S311), and the process returns to the finger movement detection routine of FIG. 14.

If the last reference position is not “E” (S309: NO), “No shift” is output in this case (S313) because the last reference position was not stored (for the first-time process) or the last reference position was “F”, and the process returns to the finger movement detection process routine of FIG. 14.

In the following, with reference to FIG. 17, we describe the finger movement determination process when the reference position is “C”. When processing of a sub-routine begins, first, “C” is made a reference position for determining the finger movement and stored in RAM 22 (S321). Then, the last reference position is retrieved from RAM 22, thereby determining the movement. It is first determined whether or not the last reference position is “A” (S323). As described earlier, the reference position “A” is output either when the density value of the left region 71 is greater than the threshold TH1 and that of the right region 72 is greater than the threshold TH3, or when the density value of the left region 71 is less than the threshold TH1 and greater than TH2 and that of the right region 72 is less than the threshold TH3 and greater than TH4. Thus, if the last reference position is “A” (S323: YES), “Minor shift to left” is output (S325), and the process returns to the finger movement detection process routine of FIG. 14.

If the last reference position is not “A” (S323: NO), it is determined whether or not the last reference position is “B” (S327). As described earlier, the reference position “B” is output when the density value of the left region 71 is greater than the threshold TH1 and that of the right region 72 is less than the threshold TH4. Thus, if the last reference position is “B” (S327: YES), “Minor shift to right” is output (S329), and the process returns to the finger movement detection process routine of FIG. 14.

If the last reference position is not “B” (S327: NO), it is determined whether or not the last reference position is “C” (S331). If the last reference position is “C” (S331: YES), “No shift” is output (S333) because the current and the last reference positions are identical, and the process returns to the finger movement detection process routine of FIG. 14.

If the last reference position is not “C” (S331: NO), it is determined whether or not the last reference position is “D” (S335). As described earlier, the reference position “D” is output either when the density value of the left region 71 is less than the threshold TH1 and greater than TH2 and that of the right region is greater than the threshold TH3, or when the density value of the left region 71 is less than the threshold TH2 and that of the right region 72 is less than the threshold TH3 and greater than TH4. Thus, if the last reference position is “D” (S335: YES), “Shift to left” is output (S337) and the process returns to the finger movement detection process routine of FIG. 14.

If the last reference position is not D (S335: NO), it is determined whether or not the last reference position is E (S339). As described earlier, the reference position E is output when the density value of the left region 71 is less than the threshold TH2 and that of the right region 72 is greater than the threshold TH3. Thus, if the last reference value is E (S339: YES), “Major shift to left” is output (S341), and the process returns to the finger movement detection process routine of FIG. 14.

If the last reference position is not “E” (S339: NO), “No shift” is output in this case (S343) because the last reference position was not stored (for the first-time process) or the last reference position was “F”, and the process returns to the finger movement detection process routine of FIG. 14.

In the following, with reference to FIG. 18, we describe the finger movement determination process when the reference position is “D”. When processing of a subroutine begins, first, “D” is made a reference position for determining the finger movement and stored in RAM 22 (S351). Then, the last reference position is retrieved from RAM 22, thereby determining the movement. First, it is determined whether or not the last reference position is “A” (S353). As described earlier, the reference position “A” is output either when the density value of the left region 71 is greater than the threshold TH1 and that of the right region 72 is greater than the threshold TH3, or when the density value of the left region 71 is less than the threshold TH1 and greater than TH2 and that of the right region 72 is less than the threshold TH3 and greater than TH4. Thus, if the last reference position is “A” (S353: YES), “Minor shift to right” is output (S335), and the process returns to the finger movement detection process routine of FIG. 14.

If the last reference position is not “A” (S353: NO), it is determined whether or not the last reference position is “B” (S357). As described earlier, the reference position “B” is output when the density value of the left region 71 is greater than the threshold TH1 and that of the right region 72 is less than the threshold TH4. Thus, the last reference position is “B” (S357: YES), “Major shift to right” is output (S359), and the process returns to the finger movement detection process routine of FIG. 14

If the last reference position is not B (S357: NO), it is determined whether or not the last reference position is C (S361). As described earlier, the reference position “C” is output either when the density value of the left region 71 is greater than the threshold TH1 and that of the right region 72 is less than the threshold TH3 and greater than TH4, or when the density value of the left region 71 is less than the threshold TH1 and greater than TH2 and that of the right region 72 is less than the threshold TH4. Thus, if the last reference position is “C” (S361: YES), “Shift to right” is output (S363), and the process returns to the finger movement detection process routine of FIG. 14.

If the last reference position is not C (S361: NO), it is determined whether or not the last reference position is D (S365). If the last reference position is “D” (S365: YES), “No shift” is output (S367) because the current and the last reference positions are identical, and the process returns to the finger movement detection process routine of FIG. 14.

If the last reference position is not “D” (S365: NO), it is determined whether or not the last reference position is “E” (S369). As described earlier, the reference position “E” is output when the density value of the left region 71 is less than the threshold TH2 and that of the right region 72 is greater than the threshold TH3. Thus, if the last reference position is E (S369: YES), “Major shift to left” is output (S371), and the process returns to the finger movement detection process of FIG. 14.

If the last reference position is not “E” (S369: NO), “No shift” is output in this case (S373) because the last reference position was not stored (for the first-time process) or the last reference position was “F”, and the process returns to the finger movement detection process routine of FIG. 14.

In the following, with reference to FIG. 19, we describe the finger movement determination process when the reference position is “E”. When processing of a subroutine begins, first, E is made a reference position for determining the finger movement and stored in RAM 22 (S381). Then, the last reference position is retrieved from RAM 22, thereby determining the movement. First, it is determined whether or not the last reference position is “A” (S383). As described earlier, the reference position “A” is output either when the density value of the left region 71 is greater than the threshold TH1 and that of the right region 72 is greater than the threshold TH3, or when the density value of the left region 71 is less than the threshold TH1 and greater than TH2 and that of the right region 72 is less than the threshold TH3 and greater than TH4. Thus, if the last reference position is “A” (S383: YES), “Shift to right” is output (S385), and the process returns to the finger movement detection process routine of FIG. 14.

If the last reference position is not “A” (S383: NO), it is determined whether or not the last reference position is “B” (S387). As described earlier, the reference position “B” is output when the density value of the left region 71 is greater than the threshold TH1 and that of the right region 72 is less than the threshold TH4. Thus, if the last reference position is B (S387: YES), “Major-Major shift to right” is output (S389), and the process returns to the finger movement detection process routine of FIG. 14.

If the last reference position is not “B” (S387: NO), it is determined whether or not the last reference position is “C” (S391). As described earlier, the reference position “C” is output either when the density value of the left region 71 is greater than the threshold TH1 and that of the right region 72 is less than the threshold TH3 and greater than TH4, or when the density value of the left region 71 is less than the threshold TH1 and greater than TH2 and that of the right region 72 is less than the threshold TH4. Thus, if the last reference position is C (S391: YES), “Major shift to right” is output (S393), and the process returns to the finger movement detection process routine of FIG. 14.

If the last reference position is not “C” (S391: NO), it is determined whether or not the last reference position is “D” (S395). As described earlier, the reference position “D” is output either when the density value of the left region 71 is less than the threshold TH1 and greater than TH2 and that of the right region 72 is greater than the threshold TH3, or when the density value of the left region 71 is less than the threshold TH2 and that of the right region 72 is less than the threshold TH3 and greater than TH4. Thus, if the last reference position is “D” (S395: YES), “Minor shift to right” is output (S397), and the process returns to the finger movement detection process routine of FIG. 14.

If the last reference position is not “D” (S395: NO), it is determined whether or not the last reference position is “E” (S399). If the last reference position is “E” (S399: YES), “No shift” is output (S401) because the current and the last reference positions are identical, and the process returns to the finger movement detection process routine of FIG. 14.

If the last reference position is not “E” (S399: NO), “No shift” is output in this case (S403) because the last reference position was not stored (for the first-time process) or the last reference position was “F”, and the process returns to the finger movement detection process routine of FIG. 14.

With the above finger movement detection process, the finger movement is output in 9 phases of “Shift to left”, “Minor shift to left”, “Major shift to left”, “Major-Major shift to left”, “Shift to right”, “Minor shift to right”, “Major shift to right”, “Major-Major shift to right” and “No shift”. Sequentially repeating the finger movement detection process could enable a finger movement to be output as a continuous value. Thus, smooth control such as gradually increasing or decreasing an angle of turning a steering wheel becomes possible if handle control information is generated based on this finger movement in the control information generation process described above. In addition, if the number of thresholds is further increased, finger movement can be detected in a greater number of phases, thereby enabling generation of detailed control information.

In the above finger movement detection process, continuous information on finger movement (finger travel distance) can be obtained by providing a plurality of thresholds for each small region. A finger position can alternatively be determined through the use of the ratio of area where a finger is placed to area of each small region. In this case, the center is expressed as 0, left as a negative value, and right as a positive value. For instance, assume that the total area of the left region 71 is 100 and the area A thereof where the finger is placed is 50. Then, assume that the area of the right region 72 is 100 and the area B thereof where the finger is placed is 30. The finger position X in this case can be determined with X=B−A, i.e., 30−50=−20, meaning that the finger is somewhat (20%) biased to the left. Then, finger travel distance can be calculated from a finger position X1 at a certain point in time and a finger position X2 that is a little earlier than X1, with an expression such as finger travel distance ΔX=X1−X2. In this example, a positive numeric value represents movement to the right direction and travel distance, while negative numeric value represents movement to the left direction and travel distance. Sequentially determining a moving direction and travel distance of a finger with such the numeric expression could enable detection of continuous movement of a finger.

The first to fourth embodiments described above are designed to detect operating input information for controlling a car driving game on the portable phone 1 by means of fingerprint image information from the fingerprint sensor 11. However, not only the drive game but also, for instance, a music performance program can be controlled through input of fingerprint information. In the following, with reference to FIG. 20 to FIG. 23, we describe a fifth embodiment wherein a violin performance program is controlled. Now, as input information to control the violin performance program, a finger rhythm detection process takes place. Since mechanical and electrical configuration of the fifth embodiment are similar to those of the first embodiment, the description of the latter are incorporated herein, and also for the control process, common parts are omitted as the description thereof is incorporated herein. FIG. 20 is a functional block diagram of the fifth embodiment. FIG. 21 is a pattern diagram of the fingerprint sensor 11 showing fingerprint image offset. FIG. 22 is a flowchart of a finger rhythm detection process in the fifth embodiment. FIG. 23 is a flowchart showing flow of the control information generation process in the fifth embodiment.

As shown in FIG. 20, in the fifth embodiment, the finger placement detection unit 51 repeatedly executes the finger placement detection process at predetermined time intervals for detecting whether or not a finger is placed on the fingerprint sensor 11, and outputs detection result thereof to the control information generation unit 50. When the detection result of “finger placement” is received from the finger placement detection unit, the control information generation unit 50 determines to start performance.

In parallel with the process at the finger placement detection unit 51, the finger rhythm detection unit 56 repeatedly executes the process of detecting whether or not the finger placed on the fingerprint sensor 11 is moving in certain rhythm. The “detection of finger rhythm” shall serve as “performance continue command information”. And “performance stop command information” is generated at the “control information generation unit 50”, when the finger rhythm is no longer detected.

In addition, in parallel with the processes at the finger placement detection unit 51 and the finger rhythm detection unit 56, the finger release detection unit 54 repeatedly executes the finger release detection process at predetermined time intervals for detecting whether or not the finger placed on the fingerprint sensor 11 has been released, and outputs the detection result to the control information generation unit 50. When the detection result of “finger release” is received from the finger placement detection unit, the control information generation unit 50 outputs performance stop command information to the performance program 57 and performance stop control is executed.

The finger placement detection unit 51, the finger rhythm detection unit 56, the finger release detection unit 54, and the control information generation unit 50, which are functional blocks in FIG. 20, are implemented by CPU21 and respective programs.

In the following, we describe the finger rhythm detection process to be executed at the finger rhythm detection unit 56, with reference to FIG. 21 and FIG. 22. To detect finger rhythm, as shown in FIG. 21, in the fingerprint sensor 11 of line type, a position that “a fingerprint pattern 81 of a partial fingerprint image acquired earlier at a certain time” most approximates “a partial image acquired later” is searched. Then, offset between the two images is measured at certain time intervals to obtain ΔY. Then, determination on presence of finger rhythm shall be made by checking if a value of the ΔY is within a certain range.

As shown in FIG. 22, when the finger rhythm detection process begins, first, a fingerprint image that will be a reference as initial setting is obtained (S411). Then, an entered image on the fingerprint sensor 11 is obtained (S413). As it will be a reference image in a next process routine, the entered fingerprint image then obtained shall be stored in RAM 22. Then, after search of positions of fingerprint patterns that most approximate between the reference image and the entered fingerprint image takes place, offset between the reference image and the entered fingerprint image ΔY is calculated (S415). Then, it is determined whether or not the calculated offset ΔY is less than the threshold A (S417). The threshold A differs depending on a type of the fingerprint sensor 11 or the portable phone 1 to be incorporated, for instance, “2” can be used.

If the offset ΔY is less than the threshold A (S417: YES), “No finger rhythm” is output (S419) because almost no offset of the finger exists, and the process proceeds to S425.

If the offset ΔY is greater than the threshold A (S417: NO), it is further determined whether or not the offset ΔY is greater than a threshold B (S421). Similar to the threshold A, although the threshold B differs depending on a type of the fingerprint sensor 11 or the portable phone 1 to be incorporated, “6”, for instance, can be used.

If the offset ΔY is greater than the threshold B (S421: YES), “No finger rhythm” is output (S419) because the finger has been substantially displaced from the last position and it is thus determined that it is hard to say the rhythm is kept. Then, the process proceeds to S425.

If the offset ΔY is less than the threshold B (S421: NO), “Finger rhythm is present” is output (S423) because the offset ΔY exists between the threshold A and threshold B, and the process should wait for predetermined time to pass (S425). After the predetermined time has elapsed, the process returns to S413 again where a fingerprint image is obtained, and the above process is repeated to calculate offset through comparison with the reference image.

In the following, referring to FIG. 23, we describe a control information generating process that controls the violin performance program by using the finger rhythm detection result obtained by the finger rhythm detection process described above.

First, as shown in FIG. 23, the finger placement detection result of the entire fingerprint sensor 11 is obtained (S431). Then, it is determined whether or not finger placement is present in the obtained finger placement detection results (S433). In the case of no finger placement (S433: NO), the process returns to S431 where the finger placement detection result is obtained again.

If the finger placement is present (S433: YES), the latest finger rhythm detection result output by the finger rhythm detection process is obtained (S435). Then, it is determined whether or not finger rhythm is present in the obtained finger rhythm detection results (S437). In the case of no finger rhythm (S437: NO), performance stop command information is generated and output to the violin performance program (S439). If it is the first time, performance shall remain unstarted because no finger rhythm has been detected yet.

If the finger rhythm is present (S437: YES), performance start command information is generated and output to the violin performance program (S441). When it receives the performance start command information, the violin performance program will start performance if the performance has not yet been executed, or continue if the performance is going on.

When S439 or S441 ends, then, finger release detection result is obtained (S443). Next, it is determined whether or not finger release is present in the obtained finger release detection result (S445). In the case of no finger release (S445: NO), the process returns to S435 where finger rhythm detection result is obtained again.

If the finger release is present (S445: YES), performance stop command information is generated and output to the violin performance program (S447). Then, the processing ends.

The method described above is not the only method to detect finger rhythm, and it may be possible to determine presence of rhythm by checking whether time interval from the finger release to the finger placement falls within a certain range. Then, with reference to FIG. 24 and FIG. 25, we describe the finger rhythm detection process by this method. FIG. 24 is a flowchart of the finger rhythm detection process by a different control method. FIG. 25 is a flowchart of a subroutine of a rhythm determination process to be executed in S463 and S471 of FIG. 24.

As shown in FIG. 24, when the process begins, first, finger placement detection result of the entire fingerprint sensor 11 is obtained (S451). Then, it is determined whether finger placement is present in the obtained finger placement detection result (S453). In the case of no finger placement (S453: NO), the process returns to S451 where finger placement detection result is obtained again.

If the finger placement is present (S453: YES), current time of day is obtained from a clock function unit 23 and stored as finger placement time in RAM 22 (S455). Then, the finger release detection result of the fingerprint sensor 11 is obtained (S457). It is then determined whether or not the finger release is present in the obtained finger release detection result (S459). In the case of no finger release (S459: NO), the process returns to S457 where finger release detection result is obtained again.

If the finger release is present (S459: YES), current time of day is obtained from the clock function unit 23 and stored as the finger release time in RAM 22 (S461). Then, a difference between the finger placement time and the finger release time is calculated and the rhythm determination process of determining whether or not finger rhythm is present is executed (S463). We later describe details of the rhythm determination process with reference to FIG. 25.

After the rhythm determination process ends, finger placement detection result is obtained again (S465). It is then determined whether or not the finger placement is present in the obtained finger placement detection result (S467). In the case of no finger placement (S467: NO), the process returns to S465 where finger placement detection result is obtained again.

If the finger placement is present (S467: YES), current time of day is obtained from the clock function unit 23 and stored as finger placement time in RAM 22 (S469). Then, a difference from the finger release time obtained and stored in S461 is calculated and the rhythm determination process of determining whether finger rhythm is present is executed according to FIG. 25 (S471). After the rhythm determination process ends, the process returns to S457. Every time finger release/finger placement is detected (S459: YES, S467/YES), the rhythm determination process (S463, S471) is repeatedly executed.

In the following, with reference to FIG. 25, we describe the rhythm determination process to be executed in S463 and S471 of FIG. 24. First, a time difference between the finger placement time and finger release time (time interval) stored in RAM 22 is calculated (S480). It is then determined whether the calculated time interval is less than a predetermined threshold A (S481). The threshold A may differ depending on a type of the fingerprint sensor 11 or the portable phone 1 to be incorporated, “0.5 second” for instance can be used.

If the time interval is less than the threshold A (S481: YES), “No finger rhythm” is output (S483) because finger placement/release state has changed almost momentarily and thus it is determined that it is hard to say that rhythm is kept. Then, the process returns to the rhythm detection process routine of FIG. 24.

If the time interval is greater than the threshold A (S481: NO), it is further determined whether or not the time interval is greater than a predetermined threshold B (S485). Similar to the threshold A, the threshold B may differ depending on a type of the fingerprint sensor 11 or the portable phone 1 to be incorporated. “1.0 second” for instance can be used.

If the time interval is greater than the threshold B (S485: YES), “No finger rhythm” is output (S483) because much time has passed since the last finger placement or finger release and it is thus determined that it is hard to say that rhythm is kept. Then, the process returns to the rhythm detection process routine of FIG. 24.

If the time interval is less than the threshold B (S485: NO), “finger rhythm present” is output (S487) because there is a time interval between the threshold A and the threshold B. Then, the process returns to the rhythm detection process routine of FIG. 24.

The first to fifth embodiment described above were intended to install the fingerprint sensor 11 in the portable phone 1, obtain state of a finger from a fingerprint image when the finger is placed on the fingerprint sensor 11, and then use it as operating input information. The operating input device/operating input program of the present invention is not limited to installation in a portable phone, but may be incorporated in a personal computer or installed in a variety of embedded devices.

Referring to FIG. 26, we describe the operating input program of the present invention is applied to a personal computer. FIG. 26 is a block diagram showing electrical configuration of a personal computer 100. As shown in FIG. 26, the personal computer 100 has well known configuration in which CPU 121 that controls the personal computer 100. To the CPU 121 are connected RAM 122 that temporarily stores data and is used as a work area of various programs, ROM 123 in which BIOS, etc. is stored, and an I/O interface 133 that serves as an intermediary in data passing. A hard disk device 130 is connected to the I/O interface 133, and in the hard disk device 130 are provided a program storage area 131 that stores various programs to be executed in CPU 121 and other information storage area 132 that stores information such as data resulting from program execution. In this embodiment, the operating input program of the present invention is stored in the program storage area 131. In addition, game programs such as a car drive game or a violin performance game, etc., are also stored in the program storage area 131.

To the I/O interface 133 are connected a video controller to which a display 102 is connected, a key controller 135 to which a keyboard 103 is connected, and a CD-ROM drive 136. A CD-ROM 137 to be inserted into the CD-ROM drive 136 stores the operating input program of the present invention. When installed, it is to be set up from the CD-ROM 137 to the hard disk device 130 and stored in the program storage area 131. Alternatively, a recording medium in which the operating input program is stored is not limited to CD-ROM, but may be a DVD or FD (flexible disk), etc. In such a case, the personal computer 100 is equipped with a DVD drive or FDD (flexible disk drive) and a recording medium is inserted into these drives. In addition, the operating input program is not limited to a type that is stored in a recording medium such as CD-ROM 137, etc., but may be configured to be downloaded from LAN or Internet to which the personal computer 100 is connected.

Similar to the one in the first to fifth embodiments that is installed on the portable phone 1, the fingerprint sensor 111 that is an input means may be any of the fingerprint sensors, such a capacitance type sensor or an optical sensor, a sensor of thermosensitive type, electric field type, planar surface type, or line type, as far as a part and/to all of a fingerprint image of a finger can be obtained as fingerprint information.

Since processes in the personal computer 100 having such the configuration do not differ from those with the case of the portable phone 1, we omit description thereof by incorporating descriptions of the above embodiments

As is well known in the art, when a game program, such as a car drive game, etc., in particular, is executed in the personal computer 100, an input device such as a joystick or a handle, etc. is connected so that a player can enjoy and feel the game more real. If such the input device could be replaced by detecting state of a finger from the fingerprint sensor 111 and generating control information, a special input device would not be necessary and space could be saved. Thus, a game program would be played enjoyably and easily on a handheld personal computer.

In addition, when a fingerprint sensor is installed in various types of embedded devices with operating switches, the operating input program of the present invention can be applied. We describe the application to an embedded device 200 with reference to FIG. 27. FIG. 27 is a block diagram showing electrical configuration of the embedded device 200. Embedded devices having a fingerprint sensor include an electronic lock that requires authentication, business equipment such as a copying machine or a printer, etc. for which access limit is desired, home appliances, etc.

As shown in FIG. 27, the embedded device 200 is provided with CPU 210 that is responsible for overall control of the embedded device 200. To the CPU 210 are connected a memory controller 220 that controls such memories as RAM 221 or nonvolatile memory 222, etc., and a peripheral controller 230 that controls peripheral devices. A fingerprint sensor 240 that is an input means, and a display 250 are connected to the peripheral controller 230. The RAM 221 that connects to the memory controller 220 is used as a work area of various programs. In addition, areas for storing various programs to be executed in CPU 210 are provided in the nonvolatile memory 222.

Similar to the one in the first to the fifth embodiments that is installed in the portable phone 1, the fingerprint sensor 240 that is an input means may be any of the fingerprint sensors, such as a capacitance type sensor or an optical sensor, a sensor of thermo sensitive type, electric field type, planar surface type, or line type, as far as a part and/to all of a fingerprint image of a finger can be obtained as fingerprint information.

Since processes in the embedded device 200 having such the configuration do not differ from those with the case of the portable phone 1 or the personal computer 100, we omit description thereof by incorporating descriptions of the above embodiments

Recently, with growing awareness about security, in areas other than computers or networking equipment, needs for application of access limits or execution of identity authentication have been increasing. The number of devices equipped with a fingerprint sensor is also expected to grow. In this context, implementation of the operating input device through the fingerprint sensor and the operating input program of the present invention could save space, cut down cost, and be useful for small-size embedded devices, in particular.

### BRIEF DESCRIPTION OF THE DRAWINGS

FIG. 1 is an external view of a portable phone 1.

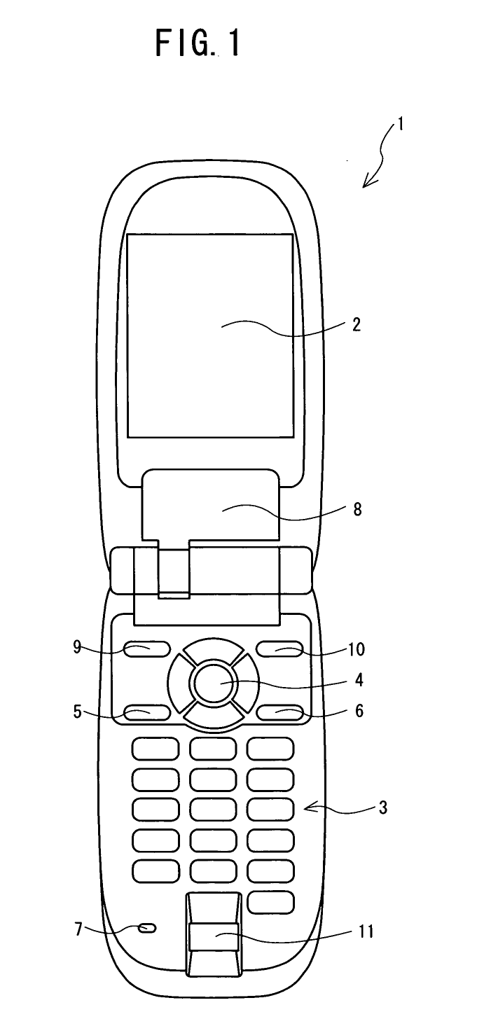

FIG. 2 is a block diagram showing electrical configuration of the portable phone 1.

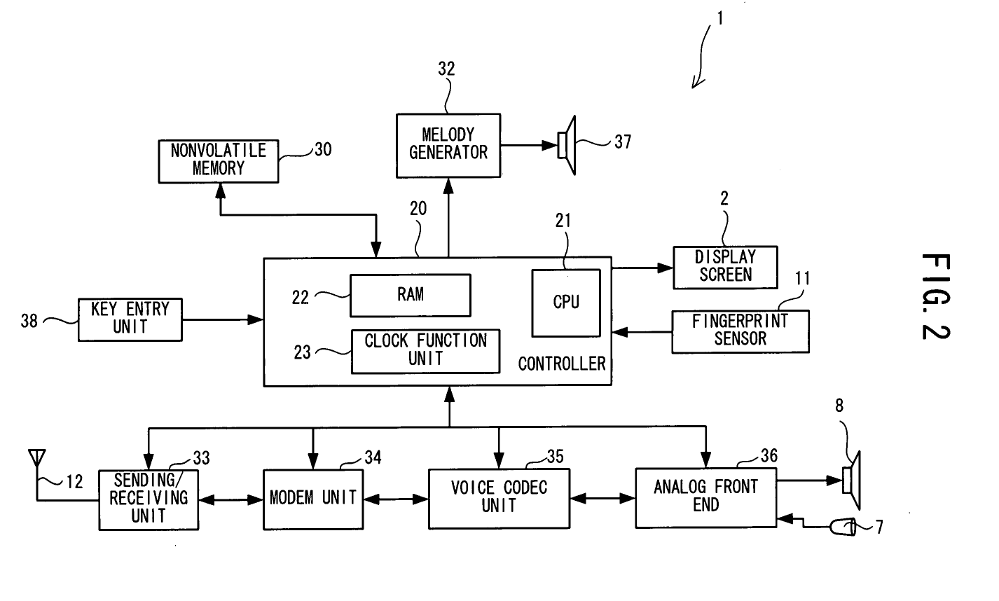

FIG. 3 is a functional block diagram of the embodiment.

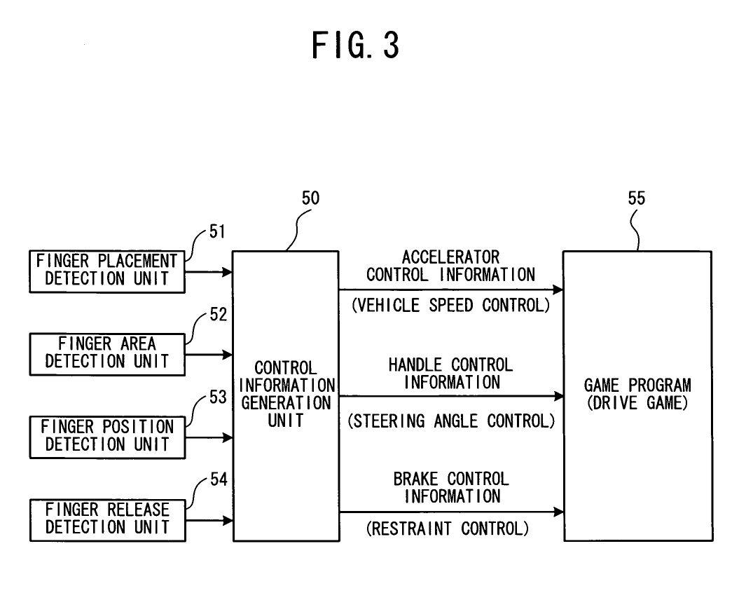

FIG. 4 is a flowchart showing flow of a finger placement detection process.

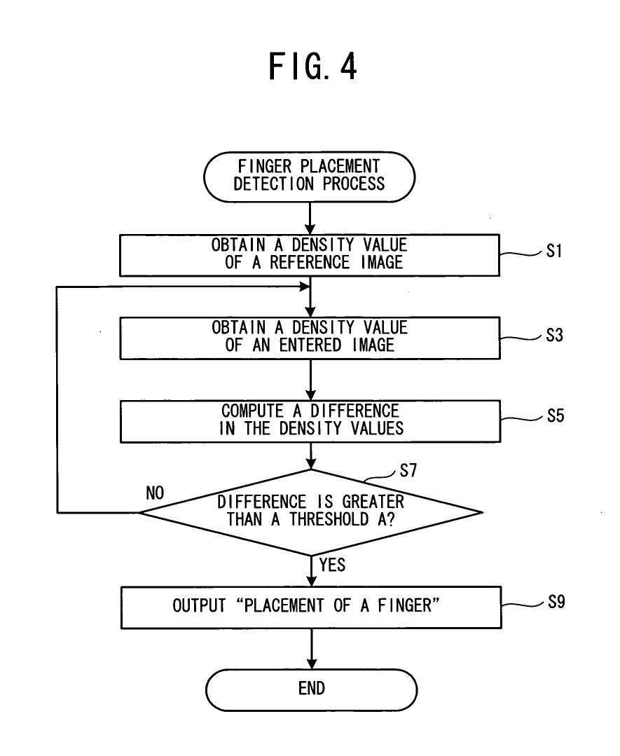

FIG. 5 is a flowchart showing flow of a finger release detection process.

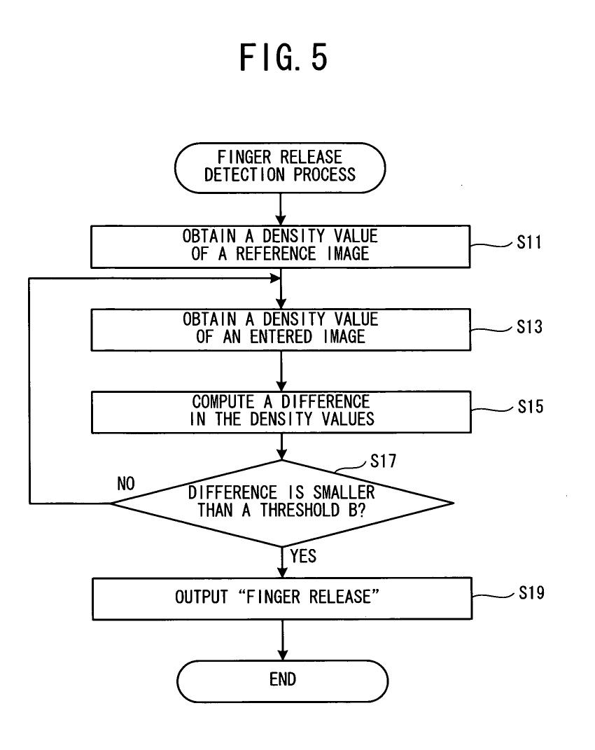

FIG. 6 is a pattern diagram of region splitting of a fingerprint sensor 11.

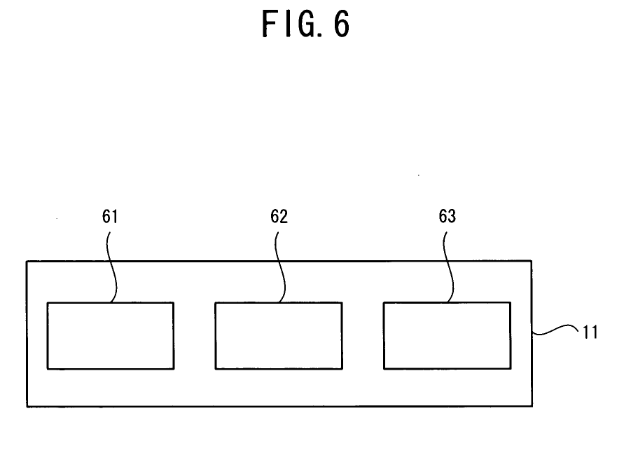

FIG. 7 is a flowchart showing flow of a finger area detection process.

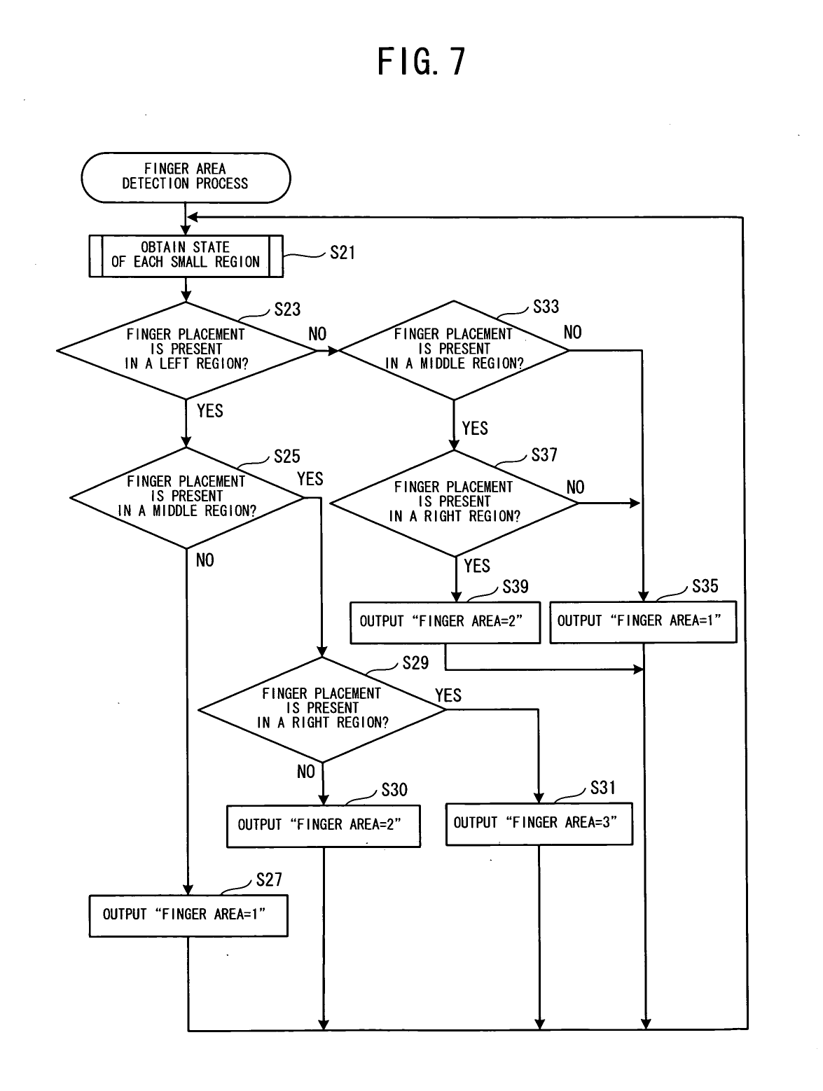

FIG. 8 is a flowchart showing flow of a finger position detection process.

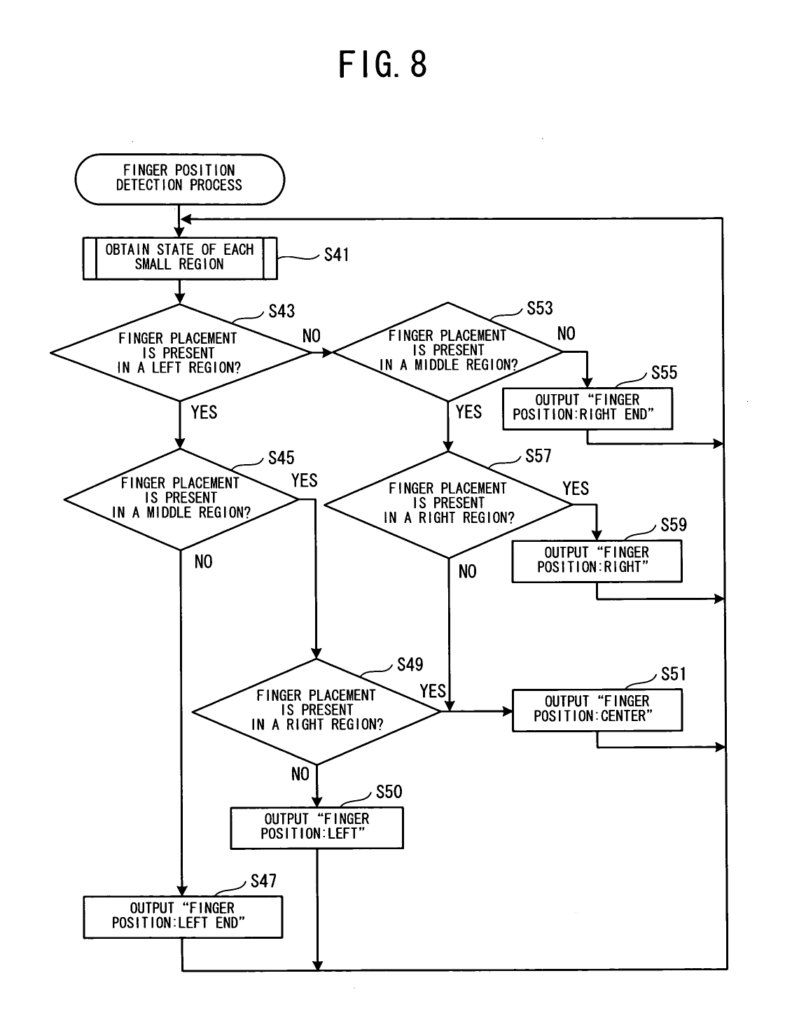

FIG. 9 is a flowchart showing a flow of a control information generation process.

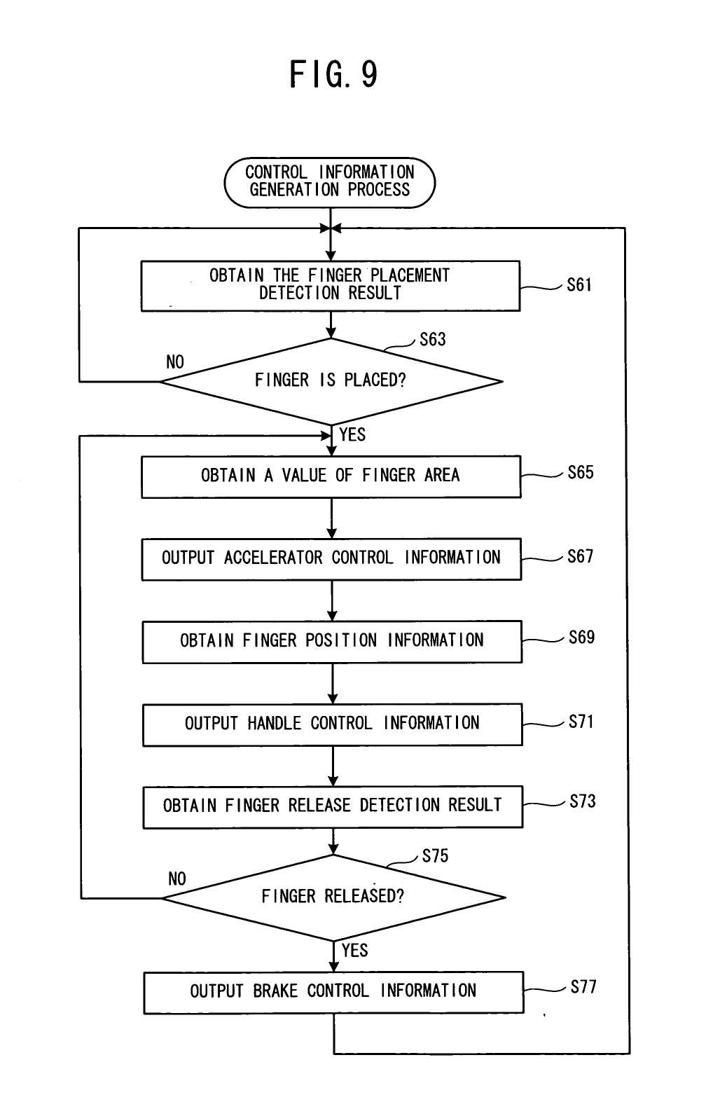

FIG. 10 is a pattern diagram of region splitting of the fingerprint sensor 11 in a second embodiment.

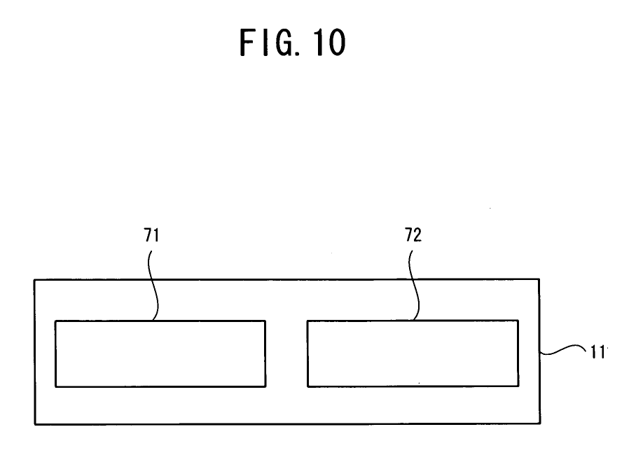

FIG. 11 is a flowchart of the finger area detection process in the second embodiment.

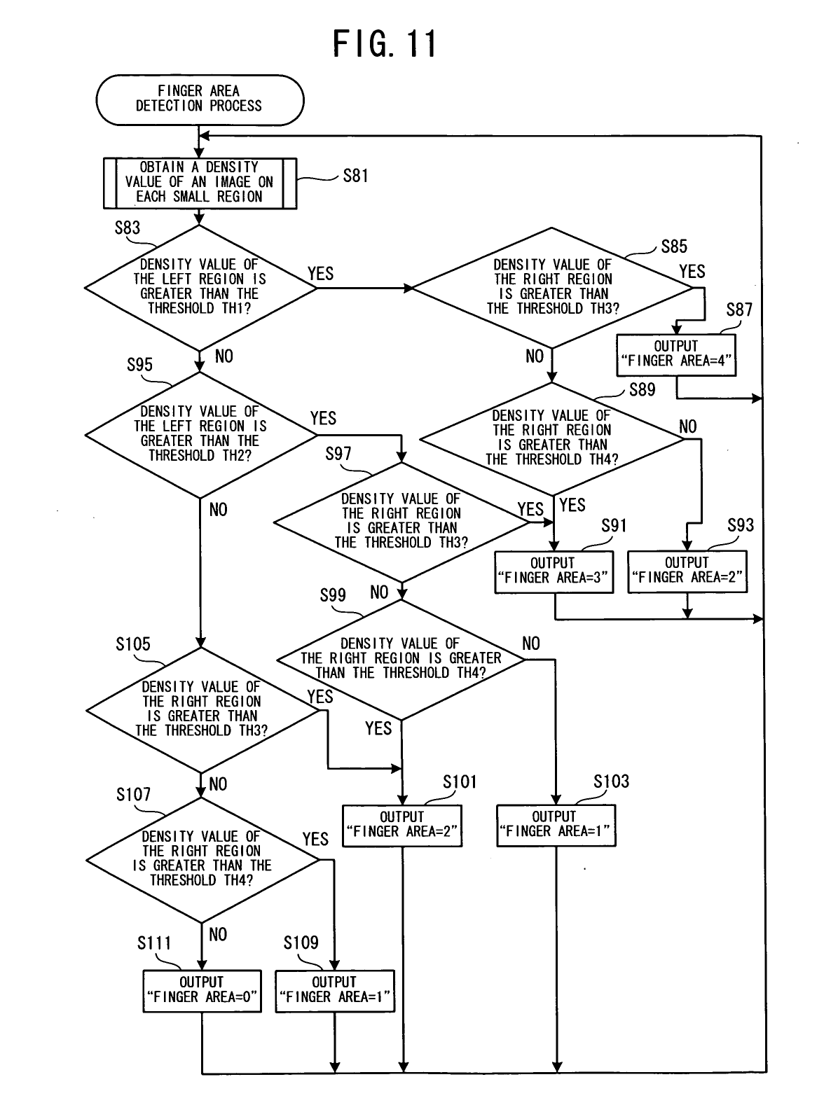

FIG. 12 is a flowchart of the finger position detection process in the second embodiment.

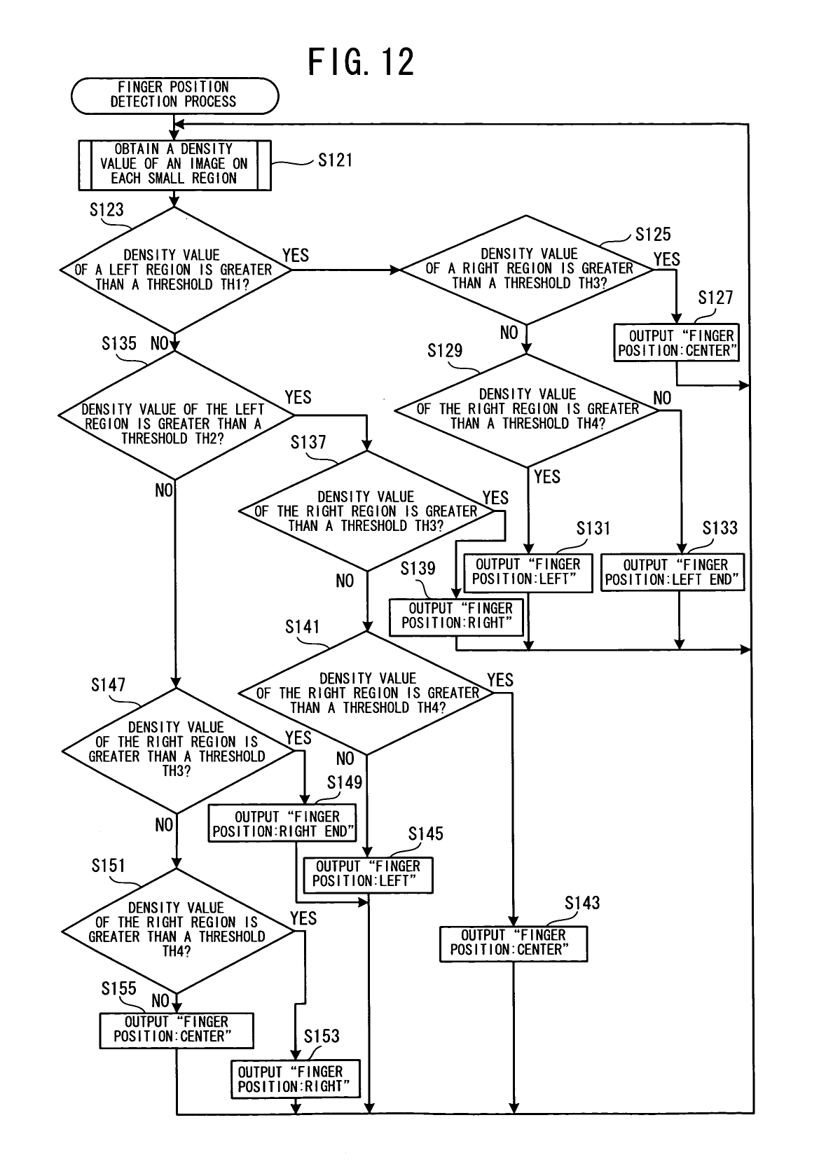

FIG. 13 is a flowchart showing flow of a finger movement detection process.

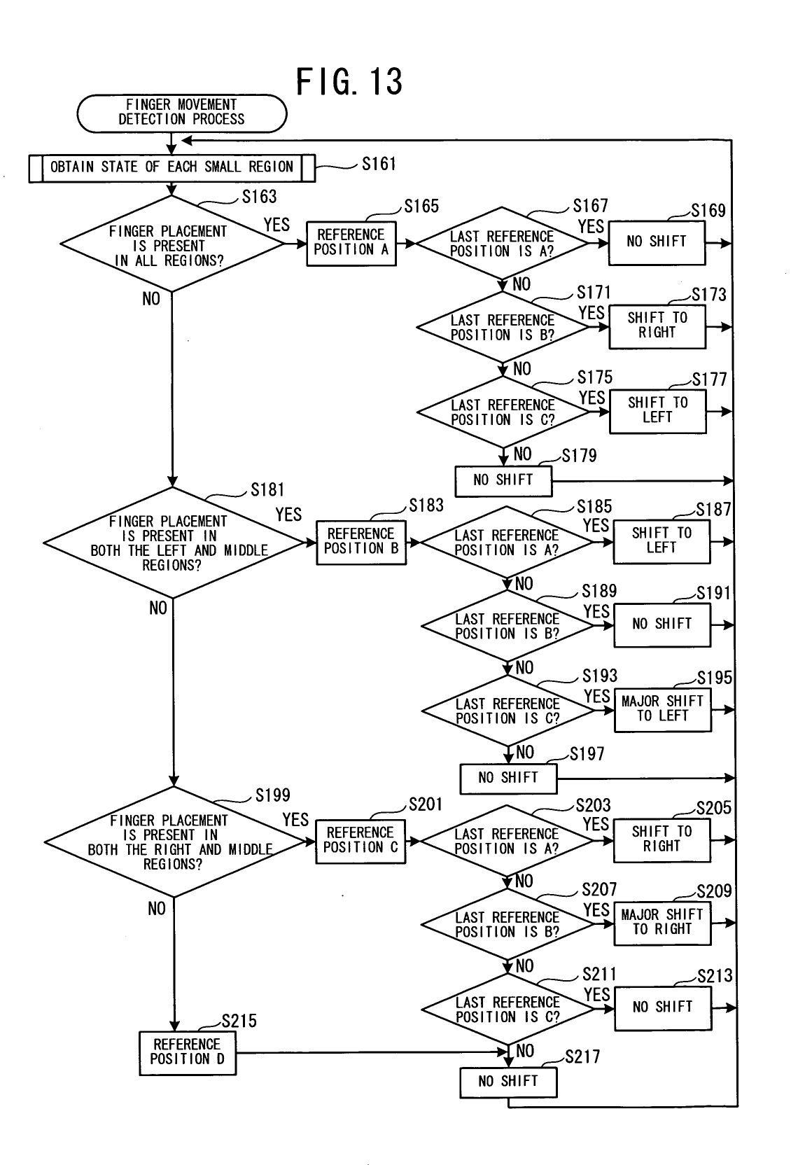

FIG. 14 is a flowchart of the finger movement detection process for obtaining continuous outputs.

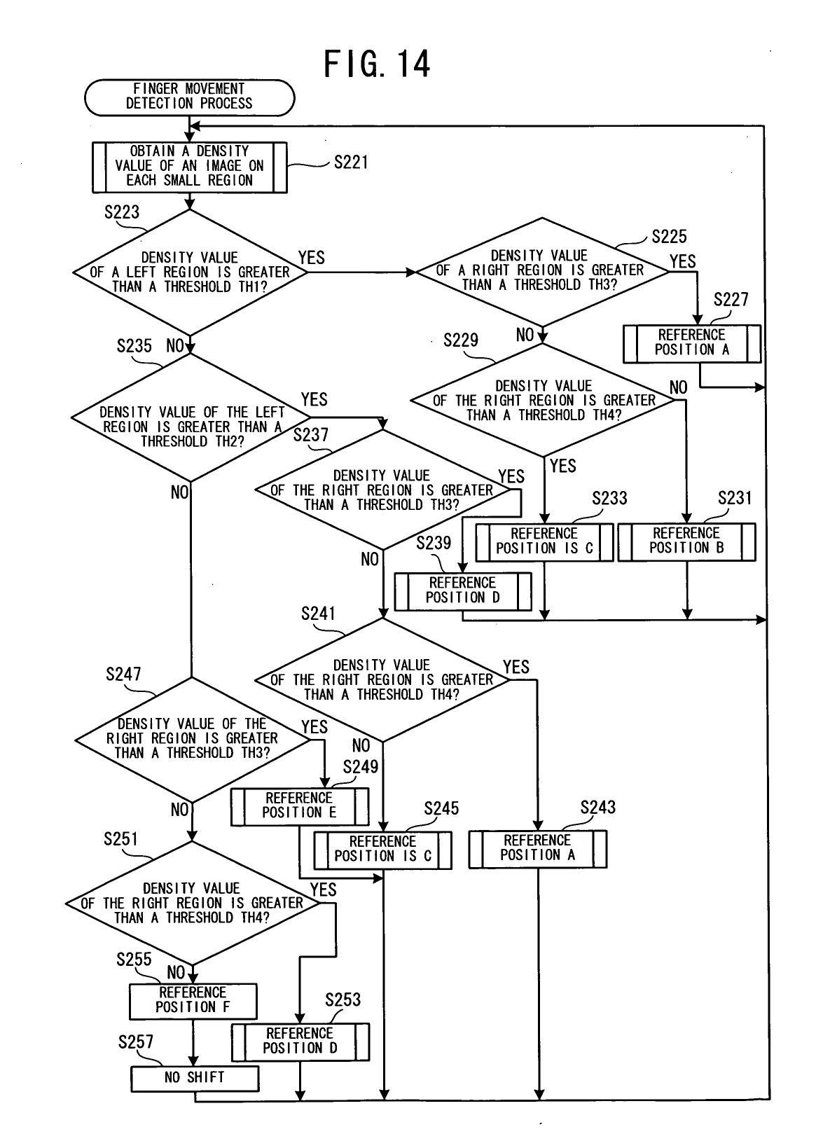

FIG. 15 is a flowchart of a subroutine in the case of a “reference position A” to be executed in S227 and S243 of FIG. 14.

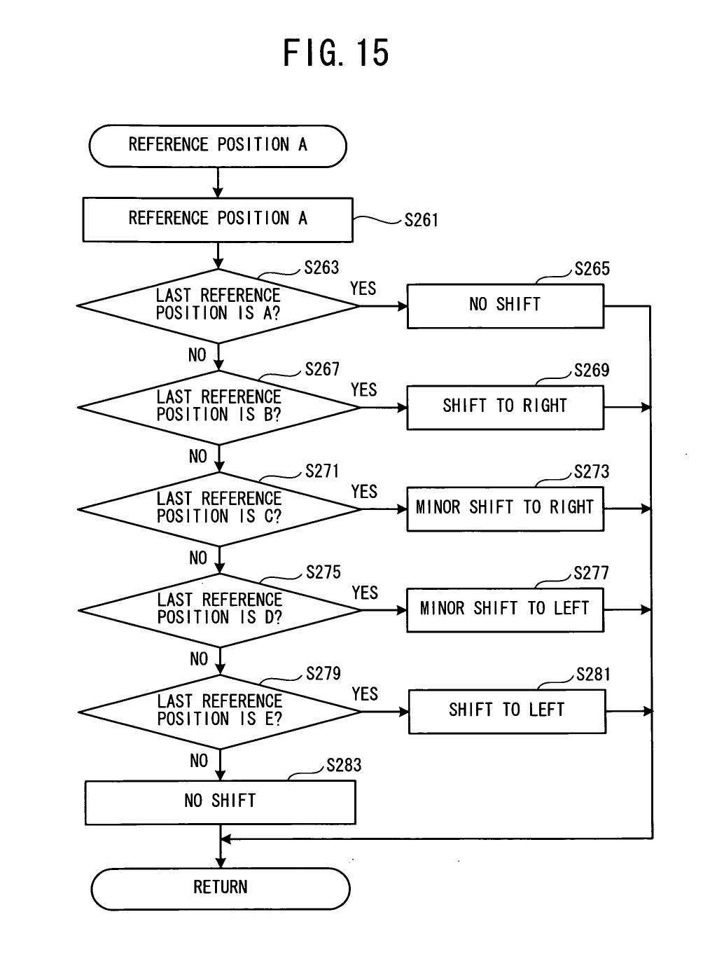

FIG. 16 is a flowchart of a subroutine in the case of a “reference position B” to be executed in S231 of FIG. 14.

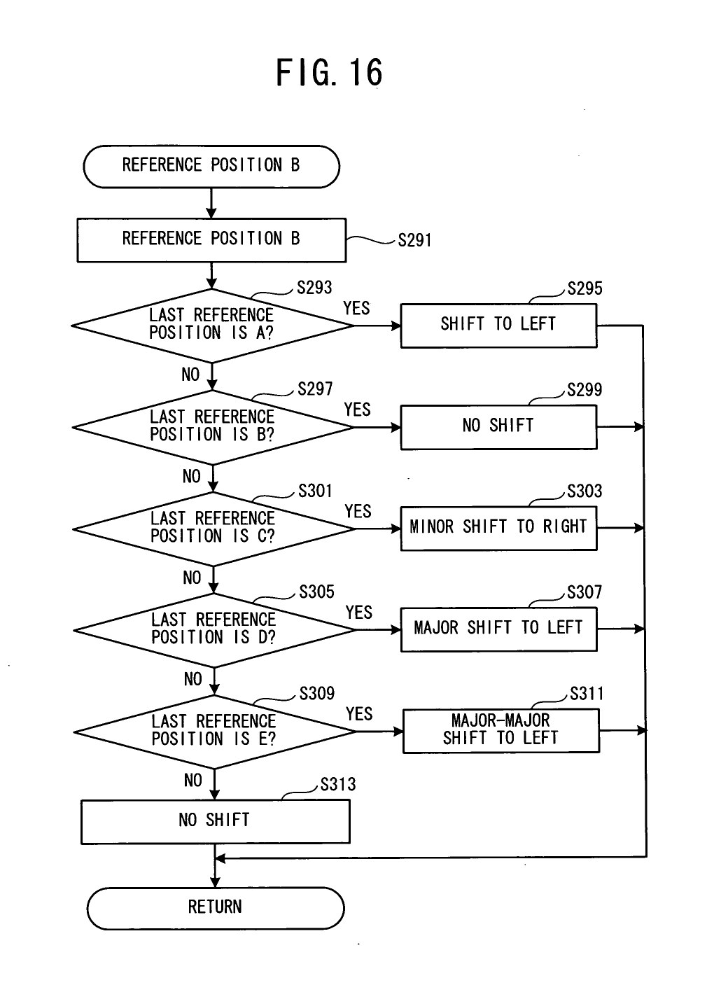

FIG. 17 is a flowchart of a subroutine in the case of a “reference position C” to be executed in S233 and S245 of FIG. 14.

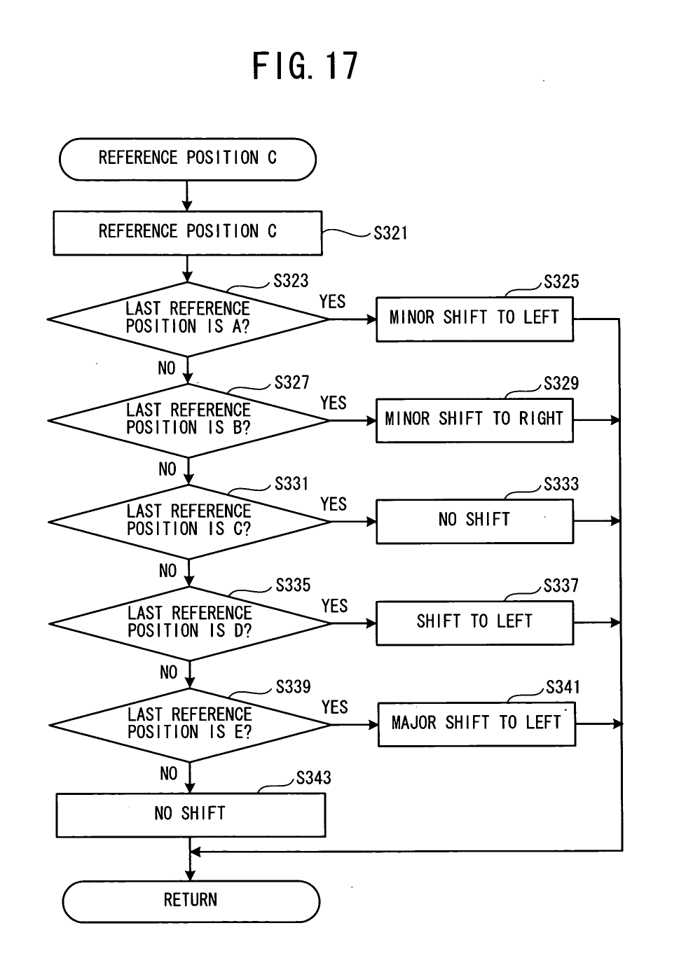

FIG. 18 is a flowchart of a subroutine in the case of a “reference position D” to be executed in S239 and S253 of FIG. 14.

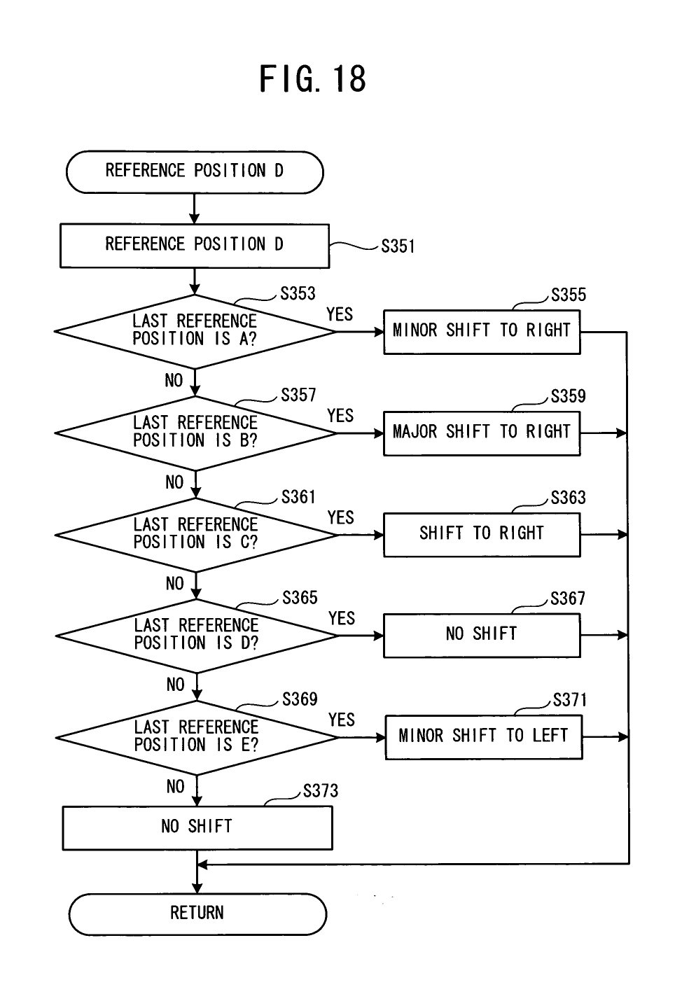

FIG. 19 is a flowchart of a subroutine in the case of a “reference position E” to be executed in S239 of FIG. 14.

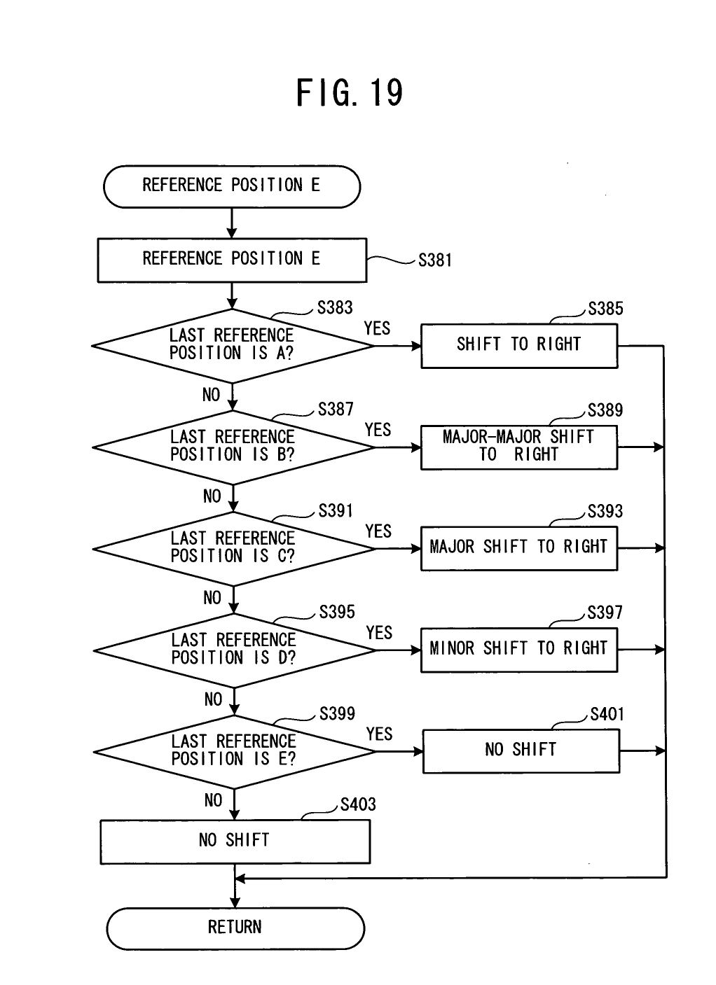

FIG. 20 is a functional block view of a fifth embodiment.

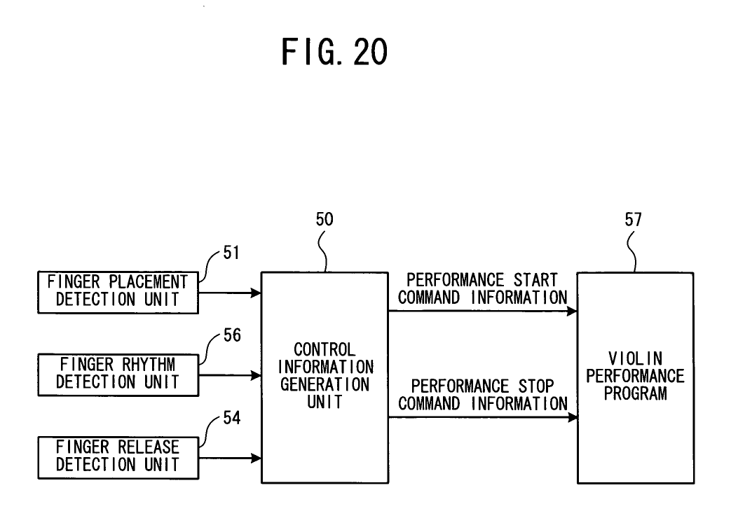

FIG. 21 is a pattern diagram showing offset of fingerprint images captured from the fingerprint sensor 11.

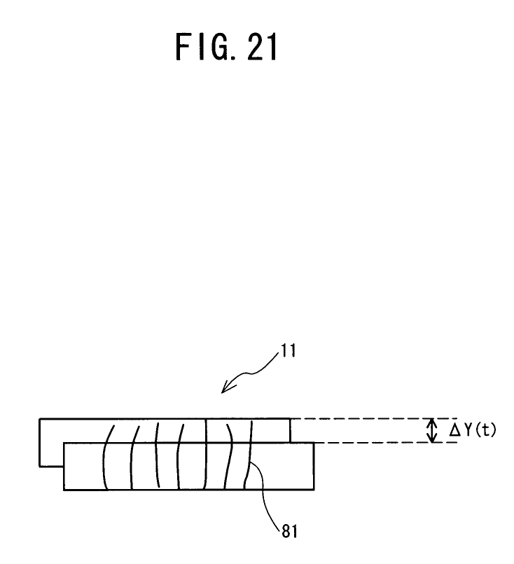

FIG. 22 is a flowchart of a finger rhythm detection process in the fifth embodiment.

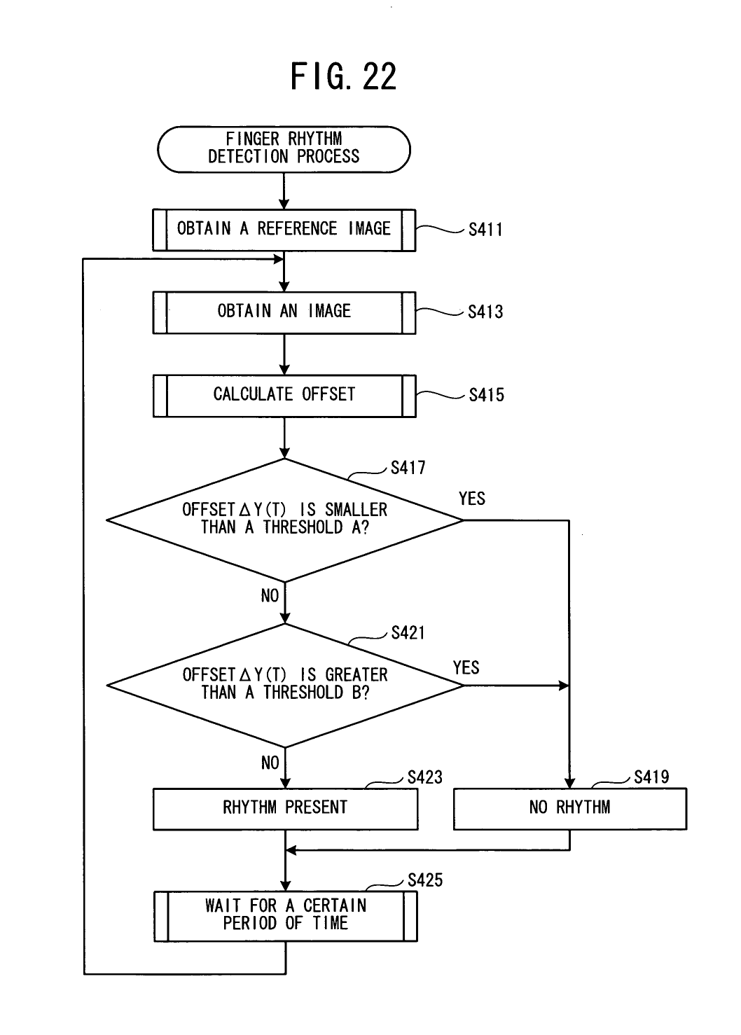

FIG. 23 is a flowchart showing flow of the control information generation process in the fifth embodiment.

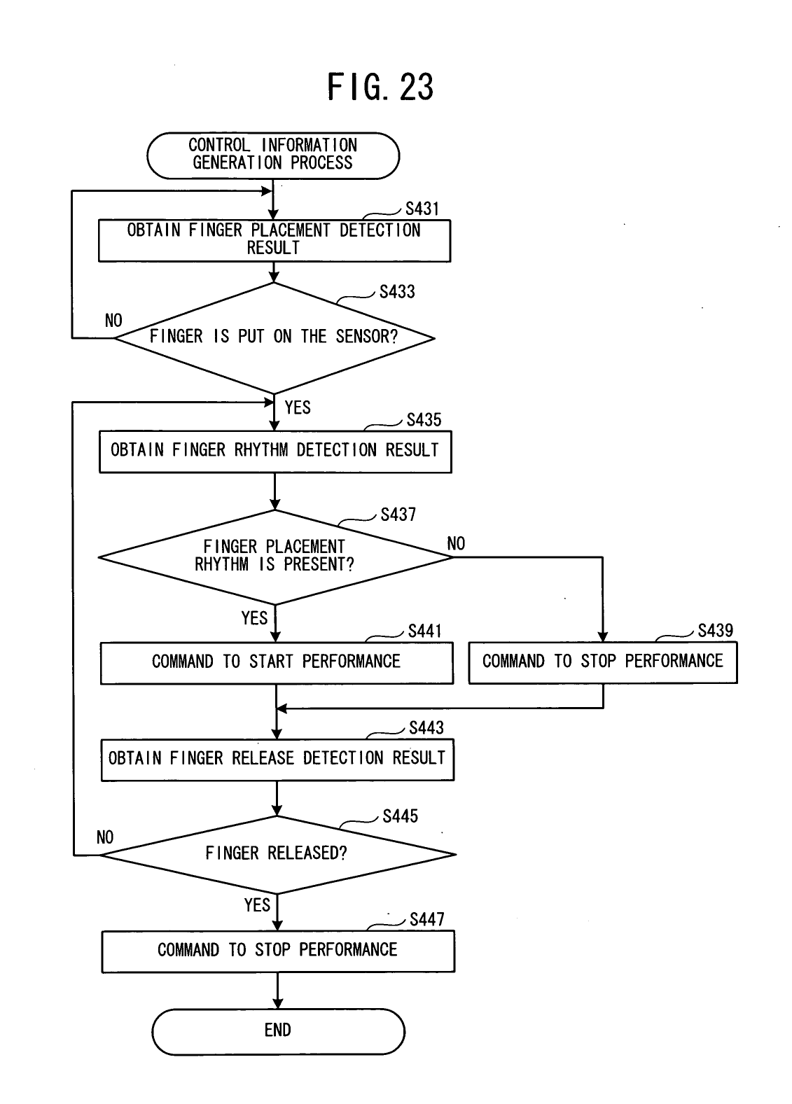

FIG. 24 is a flowchart of the finger rhythm detection process of another control method.

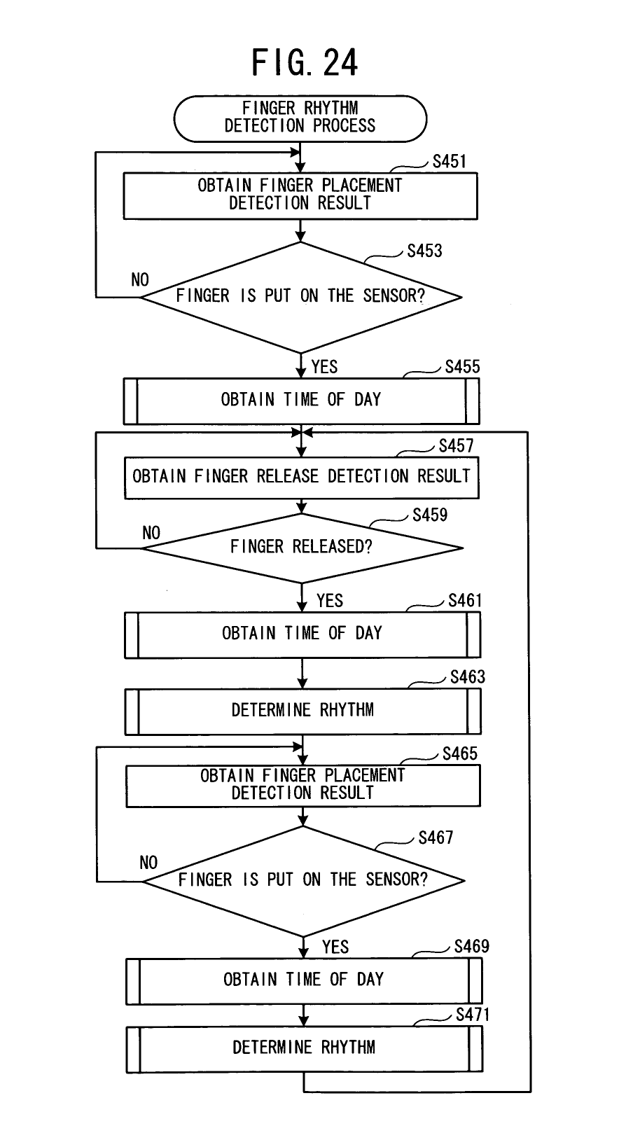

FIG. 25 is a flowchart of a subroutine of a rhythm determination process to be executed in S463 and S471 of FIG. 24.

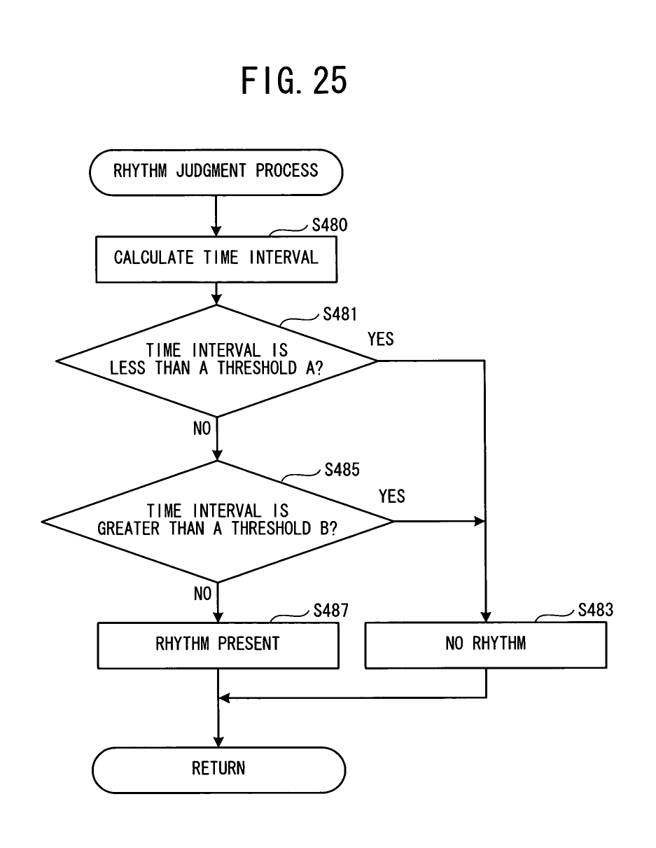

FIG. 26 is a block diagram showing electrical configuration of a personal computer 100.

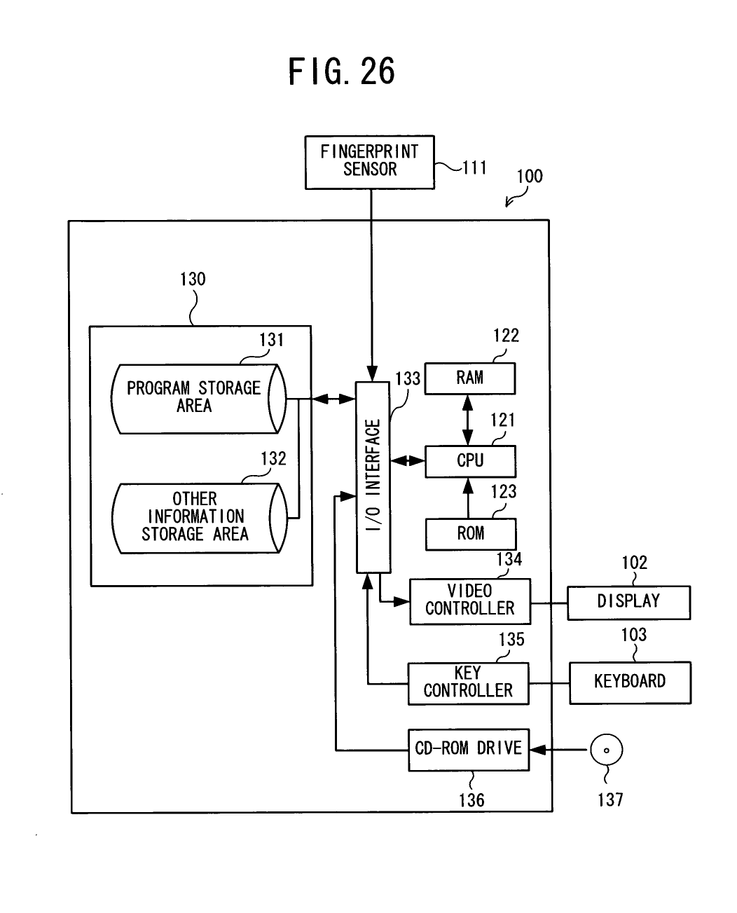

FIG. 27 is a block diagram showing electrical configuration of an embedded device 200.

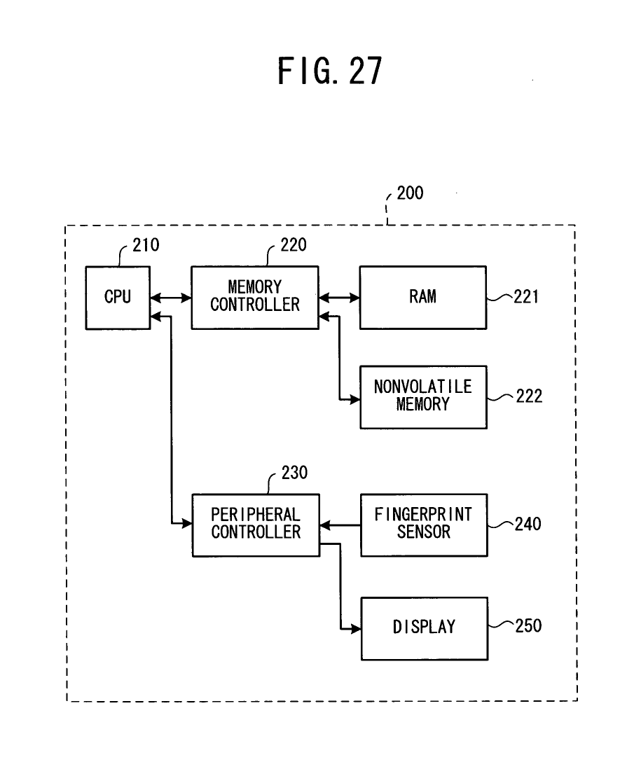

### EXPLANATION OF REFERENCE NUMERALS

1 Portable phone
11 Fingerprint sensor
21 CPU
22 RAM
30 Nonvolatile memory
32 Melody generator
33 Sending/receiving unit
34 Modem unit
34 Modem
51 Finger placement detection unit
52 Finger area detection unit
53 Finger position detection unit
54 Finger release detection unit
54 Control information generation unit
56 Finger rhythm detection unit
100 Personal computer
111 Fingerprint sensor
121 CPU
122 RAM
130 Hard disk device
131 Program storage area
200 Embedded device
210 CPU
221 RAM
240 Fingerprint sensor

1. An operating input device, comprising:
an input means for inputting a fingerprint image;
a state detection means for detecting state of a finger placed on the input means; and
a control information generation means for generating control information for a device based on detection result of the state detection means;
the operating input device is characterized in that the state detection means includes at least one of:
a finger placement detection means for detecting that a finger is placed on the input means when either a density value of a fingerprint image entered from the input means or a difference in density values of plural fingerprint images input from the input means exceeds a predetermined threshold;
a finger release detection means for detecting that a finger is released from the input means when either density values of plural fingerprint images input from the input means or a difference in the density values of plural fingerprint images input from the input means falls below a predetermined threshold;
a finger movement detection means for detecting travel distance or moving direction of a finger on the input means based on density values or fingerprint area of plural fingerprint images continuously input from regions of the input means that have been divided in advance;
a finger position detection means for detecting a position of a finger on the input means based on density values or area of the plural fingerprint images continuously input from the regions of the input means that have been divided in advance;
a finger contact area detection means for detecting contact area of a finger on the input means by calculating a difference between a density value of when no finger is placed on the input means and that of when a finger is placed on the input means; or
a finger rhythm detection means for detecting rhythm of finger movement on the input means by either calculating variation in fingerprint images input at predetermined time intervals or measuring time from finger placement to finger release on the input device.

2. The operating input device according to claim 1 characterized in that the finger movement detection means detects the travel distance or moving direction by making comparisons between each density value of the continuously input fingerprint images and a predetermined thresholds.

3. The operating input device according to claim 2 characterized in that the finger movement detection means continuously detects variation in the travel distance or moving direction of the finger by providing a plurality of the thresholds.

4. The operating input device according to claim 1 characterized in that the finger movement detection means continuously detects variation in the travel distance or moving direction of the finger by using a ratio between the region and fingerprint area in the region computed from each of the continuously input plural fingerprint images.

5. The operating input device according to claim 1 characterized in that the finger position detection means detects a finger position by making comparisons between each density value of the plural fingerprint images input continuously and a predetermined threshold.

6. The operating input device according to claim 5 characterized in that the finger position detection means detects continuous information on the finger position by providing a plurality of the thresholds.

7. The operating input device according to claim 1 characterized in that the finger position detection means detects continuous information on the finger position by using a ratio between the region and fingerprint area in the region computed from each of the continuously input plural fingerprint images.

8. The operating input device according to claim 1 characterized in that the finger contact area detection means detects continuous information on the finger contact area, by computing a difference between each density value of the fingerprint images input continuously and the density value when the no finger is placed.

9. The operating input device according claim 1, characterized in that the state detection means includes at least 2 of the finger placement detection means, the finger release detection means, the finger movement detection means, the finger position detection means, the finger contact area detection means, and the finger rhythm detection means,
wherein the control information generation means generates the control information by integrating more than one detection result from more than one means that the state detection means includes.

10. An operating input program that causes a computer to execute:
fingerprint image acquisition step of acquiring a fingerprint image;
state detection step of detecting state of a finger from the fingerprint image acquired in the fingerprint image acquisition step; and
control information generation step of generating control information of a device based on detection result in the state detection step,
the operating input program characterized in that the state detection step includes at least one of:
finger placement detection step of detecting that a finger is placed when either a density value of an acquired fingerprint image or a difference in density values of the plural acquired fingerprint images exceeds a predetermined threshold;
a finger release detection step of detecting that the finger is released when either the density value of the acquired fingerprint image or a difference in the density values of the plural acquired fingerprint image falls below a predetermined threshold;
finger movement detection step of detecting travel distance or moving direction of a finger based on density values or area of plural fingerprint images continuously acquired from regions that have been divided in advance;
finger position detection step of detecting a finger position based on density values or fingerprint area of the plural fingerprint images continuously acquired from the regions that have been divided in advance;
finger contact area detection step of detecting finger contact area by calculating a difference between a density value of when no finger is placed and that of an acquired fingerprint image; and
finger rhythm detection step of detecting rhythm of finger movement by either computing variation in fingerprint images input at predetermined time intervals or measuring time from finger placement to finger release.

11. The operating input program according to claim 10 characterized in that the finger movement detection step detects the travel distance or moving direction by making comparisons between each density value of the continuously acquired fingerprint images and predetermined thresholds.

12. The operating input program according to claim 11 characterized in that the finger movement detection step continuously detects variation in the travel distance or moving direction of a finger by providing a plurality of the thresholds.

13. The operating input program according to claim 10 characterized in that the finger movement detection step continuously detects variation in the travel distance or moving direction of the finger by using a ratio between the region and fingerprint area in the region computed from each of the continuously input plural fingerprint images.

14. The operating input program according to claim 10 characterized in that the finger position detection step detects a finger position by making comparisons between each density value of the plural fingerprint images acquired continuously and a predetermined threshold.

15. The operating input program according to claim 14 characterized in that the finger position detection step detects continuous information on the finger position by providing a plurality of the thresholds.

16. The operating input program according to claim 10 characterized in that the finger position detection step detects continuous information of the finger position by using a ratio between the region and fingerprint area in the region computed from each of the continuously acquired plural fingerprint images.

17. The operating input program according to claim 10 characterized in that the finger contact area detection step detects continuous information on the finger contact area, by computing a difference between each density value of the fingerprint images acquired continuously and the density value when no finger is placed.

18. The operating input program according to claim 10 characterized in that the state detection step includes at least 2 steps of the finger placement detection step, the finger release detection step, the finger position detection step, the finger contact area detection step, and the finger rhythm detection step; and said control information generation step generates the control information by integrating detection results detected in the more than one step that the state detection step includes.
